(19) United States
(12) Patent Application Publication
(10) Pub. No.: US 2015/0268336 A1
(43) Pub. Date: Sep. 24, 2015

(54) ANTENNA APPARATUS, RADAR APPARATUS AND ON-VEHICLE RADAR SYSTEM

(71) Applicant: DENSO CORPORATION, Kariya-shi (JP)

(72) Inventors: Masanobu YUKUMATSU, Kariya-shi (JP); Asahi KONDOU, Kariya-shi (JP); Yasuyuki MIYAKE, Toyota-shi (JP)

(21) Appl. No.: 14/730,283

(22) Filed: Jun. 4, 2015

Related U.S. Application Data
(62) Division of application No. 13/361,221, filed on Jan. 30, 2012.

(30) Foreign Application Priority Data
Jan. 31, 2011 (JP) 2011-018101
Jan. 31, 2011 (JP) 2011-018102

(51) Int. Cl. G01S 13/04; G01S 13/87; G01S 7/28; G01S 13/58; G01S 7/35

(52) U.S. Cl. CPC G01S 13/04; G01S 13/58; G01S 7/35; G01S 7/28; G01S 13/87

(57) ABSTRACT

An antenna apparatus includes a substrate, a first antenna, and a second antenna. The substrate includes two or more pattern-forming layers which are layered via at least one insulating layer. The two or more pattern-forming layers include a first pattern-forming layer and a second pattern-forming layer which are different from each other. The first pattern-forming layer forms one of both outer layers located at both surfaces of the substrate. The first antenna is formed on the first pattern-forming layer, includes a plurality of antenna elements arrayed in a row, and radiates electromagnetic waves in a layer direction of the plurality of layers. The second antenna is formed on the second pattern-forming layer, is arranged on at least one side of both sides of the antenna array direction of the plurality of antenna elements of the first antenna section, and radiates electromagnetic waves in the antenna array direction.

### CROSS-REFERENCE TO RELATED APPLICATION

This application is a divisional application of U.S. patent application Ser. No. 13/361,221 filed on Jan. 30, 2012. This application claims the benefit and priority of Japanese Patent Application Nos. 2011-018102 and 2011-018101 both filed Jan. 31, 2011. The entire disclosures of each of the above applications are incorporated herein by reference.

### BACKGROUND OF THE INVENTION

1. Technical Field of the Invention

The present invention relates to an antenna apparatus, a radar apparatus, and an on-vehicle radar system, and in particular to an antenna apparatus used for transmitting/receiving electromagnetic waves, a radar apparatus including the antenna apparatus, an on-vehicle radar apparatus mounted on a vehicle which detects targets (objects) around a vehicle, and an on-vehicle radar system including the radar apparatus.

2. Related Art

In the radar apparatus of the related art, some techniques for realizing a broad detection area are known. As one of such techniques, JP-A-2007-049691 discloses an antenna module including a first antenna and a second antenna which are disposed on the same antenna substrate. The first antenna acts as a planar radiation antenna such as a so-called “broadside array antenna” and radiates electromagnetic waves in a direction perpendicular to a pattern-formed plane of the substrate. The second antenna acts as a horizontal radiation antenna such as a so-called “end-fire array antenna” and radiates electromagnetic waves in a direction parallel to the pattern-formed plane of the substrate. Both antennas are formed on the same surface of the same antenna substrate.

In the above related art, the first antenna is composed of a plurality of antennas (hereinafter, also collectively referred to as “first antenna group”) that are arrayed in a row on the antenna substrate to form a plurality of beams in different directions along an antenna array direction thereof. The second antenna is arranged at both ends in an antenna array direction of the first antenna group to form beams which are directed to (i.e., so that a detection area is set) the outside of the region (detection area) covered by the beams from the first antenna group.

In the antenna substrate of the above related art, the direction of beams (radiation direction) of the second antenna is directed to the outer side of the detection area of the first antenna group, but is limited to a direction in the pattern-formed plane of the antenna substrate. Thus, the above related art has suffered from a problem of not being able to cover a broader detection area.

On the other hand, it is considered that a radar apparatus capable of realizing the above broad detection area can be used to be mounted on, e.g., the four corners (i.e., front-left, front-right, rear-left and rear-right corners) of the vehicle such that, e.g., the detection area of the radar apparatus at the rear-right corner can cover an area that ranges from the right rear to the right side of the vehicle.

In the front and rear of the vehicle, the detection area is needed to cover an area ranging up to a relatively long distance area, but in the both sides of the vehicle, the detection area may cover an area with the order of a road width. However, in the sides of the vehicle, a distance is desired to be measured at high resolution in order to accurately judge the risk of collision or contact with another vehicle.

In consideration for the above, the antenna substrate may be mounted on the vehicle such that the detection area of the first antenna group is located at the rear of the vehicle, and the second antenna at one side of the first antenna group is located at the sides of the vehicle. Here, when a target is detected through the second antenna, ultra wide band (UWB) modulation may be applied so as to achieve a high distance-resolution, and, for example, the radar apparatus may be operated as a pulse radar using a pulse with very narrow pulse width.

In this case, in target detection in the detection area at the sides of the vehicle using the second antenna, a relative speed with respect to the target cannot be detected by one measurement. Therefore, it is impossible to immediately judge whether a detected target is a stopped object (e.g., roadside object) or a moving object (e.g., vehicle) needed to be tracked.

### SUMMARY

The present disclosure has been made in light of the problem set forth above and provides an antenna apparatus which is able to cover a broad detection area exceeding a detection angle of 180° using antennas formed on a single substrate, and to provide a radar apparatus using the antenna apparatus and also to provide an on-vehicle radar system using the radar apparatus.

The present disclosure also provides, in a radar apparatus that detects targets in a plurality of detection areas including a detection area in which information other than a distance to a target cannot be obtained, a radar apparatus that immediately can judge whether or not a target is a moving object in the detection area in which information other than the distance to the target cannot be obtained.

In order to achieve the object set forth above, the antenna apparatus of the present disclosure includes a substrate having two or more pattern-forming layers.

Of the pattern-forming layers, a pattern-forming that is an outer layer has one surface contacting an insulating layer and the other surface exposed to the outside. This outer layer is formed with a first antenna section made up of a plurality of first antenna elements. The first antenna elements are arrayed in a row to radiate electromagnetic waves toward a direction in which the pattern-forming layers are layered (i.e. direction perpendicular to the planes of the pattern-forming layers).

Of the pattern-forming layers, a pattern-forming layer, which is different from the outer layer formed with the first antenna section, is formed with a second antenna section. The second antenna section is formed at least at one of the two ends of the pattern-forming layer with respect to a direction in which the first antenna elements are arrayed (hereinafter referred to as “antenna array direction”). The second antenna section is composed of one or more second antenna elements which radiate electromagnetic waves toward the antenna array direction.

According to a first exemplary aspect of the present disclosure, there is provided an antenna apparatus, comprising: (i) a substrate that includes two or more pattern-forming layers which are layered via at least one insulating layer, the two or more pattern-forming layers including a first pattern-forming layer and a second pattern-forming layer, the first pattern-forming layer forming one of outer layers located at surfaces of the substrate; (ii) a first antenna that is formed on the first pattern-forming layer, includes a plurality of antenna elements arrayed in a row, and radiates electromagnetic waves in a layer direction of the plurality of layers corresponding to a direction perpendicular to an antenna array direction of the plurality of antenna elements; and (iii) a second antenna that is formed on the second pattern-forming layer, is arranged on at least one side of both sides in the antenna array direction of the plurality of antenna elements of the first antenna section, and radiates electromagnetic waves in the antenna array direction.

Thus, according to the antenna apparatus configured as described above, the second antenna section is formed in a pattern-forming layer different from the one in which the first antenna section is formed. Therefore, compared with the case where the second antenna section and the first antenna section are both formed in the same pattern-forming layer, directivity of the second antenna section can be farther directed toward the rear surface opposite to the surface in which the first antenna section is formed.

The second antenna may be formed on the second pattern-forming layer that forms the other of both outer layers located at both surfaces of the substrate. The second antenna may be formed on the second pattern-forming layer that forms an inner layer whose both planes face the insulating layer.

The two or more pattern-forming layers may include a third pattern-forming layer formed between the first pattern-forming layer and the second pattern-forming layer, the third pattern-forming layer allowing electric power to be fed to the second antenna from the third pattern-forming layer.

In this case, radiation of electromagnetic waves leaking from the electric supply line can be reduced. Accordingly, disturbance in the directivity of the second antenna section is suppressed, which disturbance would otherwise have been caused by the leakage of radiation from the electric supply line.

The first antenna may include a transmitting antenna section and a receiving antenna section which are arranged in the antenna array direction, each of the transmitting antenna section and the receiving antenna section being composed of the plurality of antenna elements.

The second antenna may include a transmitting antenna section and a receiving antenna section which are arranged in a direction perpendicular to the antenna array direction, each of the transmitting antenna section and the receiving antenna section being composed of at least one antenna element.

Thus, owing to the provision of the dedicated transmitting antenna section and receiving antenna section for transmitting and receiving electromagnetic waves, the antenna apparatus can be configured without using high-cost components, such as a circulator for separating transmission signals from reception signals.

In the antenna apparatus, the plurality of antenna elements of the first antenna may be composed of a plurality of patch antennas that are arrayed in one or more rows in a direction perpendicular to the antenna array direction. In this case, the beam width of the first antenna elements can be narrowed down in the direction of array of the patch antennas.

The second antenna section may be composed of a tapered slot antenna. In this case, a high bandwidth is available for the second antenna elements. Thus, the second antenna elements may also be favorably used for ultra wide band (UWB) modulation.

The antenna apparatus may further comprise: a transceiver that transmits electromagnetic waves via the first antenna section; and a receiver that receives electromagnetic wavess via the second antenna section, wherein the transceiver and the receiver are composed of electric components that are mounted on the other of both outer layers located at both surfaces of the substrate. In other words, the second antenna section may be formed in the parts-mounted surface of the substrate. In this case, the size of the antenna apparatus can be reduced.

According to a second exemplary aspect of the present disclosure there is provided a radar apparatus, comprising: (a) an antenna apparatus, including (a1) a substrate that includes two or more pattern-forming layers which are layered via at least one insulating layer, the two or more pattern-forming layers including a first pattern-forming layer and a second pattern-forming layer, the first pattern-forming layer forming one of outer layers located at surfaces of the substrate, (a2) a first antenna that is formed on the first pattern-forming layer, includes a plurality of antenna elements arrayed in a row, and radiates electromagnetic waves in a layer direction of the plurality of layers corresponding to a direction perpendicular to an antenna array direction of the plurality of antenna elements; and (a3) a second antenna that is formed on the second pattern-forming layer, is arranged on at least one side of both sides in the antenna array direction of the plurality of antenna elements of the first antenna section, and radiates electromagnetic waves in the antenna array direction; (b) a transmitter that selects one of the first antenna and second antenna, and transmits electromagnetic waves via a selected one of the first antenna and second antenna; (c) a receiver that selects one of the first antenna and second antenna, and receives electromagnetic waves via a selected one of the first antenna and second antenna; and (d) a signal processor that selects one of the first antenna and second antenna for a transmission and reception, allows electromagnetic waves to be transmitted by the transmitter, and performs a process to detect a target based on a signal received by the receiver.

According to the radar apparatus of the present disclosure configured as described above, a target can be detected through detection areas covering a large angle range exceeding 180°, for example, with the use of the antenna apparatus described above.

The transmitter may include an amplitude and phase control circuit controls an amplitude and phase of a transmitting signal that is supplied to each of the plurality of antenna elements to change a directivity of electromagnetic waves transmitted through the first antenna.

The receiver may independently supply each of reception signals from each of the plurality of antenna elements to the signal processor, and the signal processor may perform a process to estimate a direction of arrival of electromagnetic waves based on phase information of each of the reception signals.

In the radar apparatus, each operation of the transmitter and the receiver may be controlled such that, when the transmitter transmits electromagnetic waves via the first antenna, the receiver receives electromagnetic waves via the first antenna, and, when the transmitter transmits electromagnetic waves via the second antenna, the receiver receives electromagnetic waves via the second antenna. In this case, a target can be detected using the detection areas of the antenna sections to a maximum extent.

Other than this, the operation of the transmission section and the reception section may be controlled so that the transmission section transmits electromagnetic waves via the first antenna section and the reception section receives electromagnetic waves via the second antenna section. Alternatively, the operation of the transmission section and the reception section may be controlled so that the transmission section transmits electromagnetic waves via the second antenna section and the reception section receives electromagnetic waves via the first antenna section. However, in this case, it is required that the detection area of the first antenna section is ensured to be partially overlapped with the detection area of the second antenna section, for the detection of objects in the region where the detection areas are overlapped.

In the radar apparatus, the transmitter and the receiver may have a pulse wave mode that is an operation mode in which pulse waves are transmitted and received and a continuous wave mode that is an operation mode in which continuous waves are transmitted and received.

In this case, the transmitter and the receiver may be operated under the pulse wave mode when the first antenna is used, and may be operated under the continuous wave mode when the second antenna is used.

When ultra wide band (UWB) modulated pulses are used, a target is detected with high distance resolution. Further, in the continuous-wave (CW) mode, FMCW (frequency modulated continuous wave) or multifrequency CW can be used. In particular, when CW is used without being frequency-modulated, a target whose relative speed to own radar apparatus is zero cannot be detected. Thus, for example, the radar apparatus can be favorably used for the case where only the surrounding moving targets are desired to be detected in a state where the vehicle installing the on-vehicle radar system is stopped.

According to a third exemplary aspect of the present disclosure, there is provided an on-board radar system, comprising: two radar apparatuses that are a first radar apparatus and a second radar apparatus which are mounted on a vehicle, each comprising, (a) an antenna apparatus, including (a1) a substrate that includes two or more pattern-forming layers which are layered via at least one insulating layer, the two or more pattern-forming layers including a first pattern-forming layer and a second pattern-forming layer, the first pattern-forming layer forming one of outer layers located at surfaces of the substrate, (a2) a first antenna that is formed on the first pattern-forming layer, includes a plurality of antenna elements arrayed in a row, and radiates electromagnetic waves in a layer direction of the plurality of layers corresponding to a direction perpendicular to an antenna array direction of the plurality of antenna elements; and (a3) a second antenna that is formed on the second pattern-forming layer, is arranged on at least one side of both sides in the antenna array direction of the plurality of antenna elements of the first antenna section, and radiates electromagnetic waves in the antenna array direction, (b) a transmitter that selects one of the first antenna and second antenna, and transmits electromagnetic waves via a selected one of the first antenna and second antenna, (c) a receiver that selects one of the first antenna and second antenna, and receives electromagnetic waves via a selected one of the first antenna and second antenna, and (d) a signal processor that selects one of the first antenna and second antenna for a transmission and reception, allows electromagnetic waves to be transmitted by the transmitter, and performs a process to detect a target based on a signal received by the receiver, wherein, provided that a detection area of the first antenna is a first area and a detection area of the second antenna is a second antenna, the first radar apparatus is mounted on the vehicle such that the first area is positioned at the rear-right side of the vehicle and the second area is positioned at the right side of the vehicle, and the second radar apparatus is mounted on a vehicle such that the first area is positioned at the rear-left side of the vehicle and the second area is positioned at the left side of the vehicle.

With this configuration, the two radar apparatuses are able to cover a wide range extending from the rearward direction of the vehicle to both sides of the vehicle. In addition, the configuration of the on-vehicle radar system is simplified.

The first area may be a rear approaching vehicle detection area that is set for detecting another vehicle approaching from the rear of own vehicle, or a rear crossing vehicle detection area that is set for detecting another vehicle crossing the rear of own vehicle on moving into the rear of own vehicle. The second area may be a blind spot vehicle detection area that is set for detecting another vehicle which exists in a blind spot of a driver of own vehicle.

The on-board radar system may further comprise: a system controller that operates the two radar apparatus under different operation mode from the each other.

With this configuration, the two radar apparatuses are not only efficiently operated but also suppressed from interfering with each other.

According to a fourth exemplary aspect of the present disclosure, there is provided radar apparatus mounted on a vehicle, comprising: (i) a first antenna and a second antenna mounted on the vehicle; (ii) a rear detection unit that detects a position and relative speed of a target which exists in a rear detection area that is set in the rear of own vehicle, under the condition that electromagnetic waves are transmitted and received through the first antenna; (iii) a side detection unit that detects a distance to a target which exists in a side detection area that is set in the side of own vehicle such that an overlap area is included between the side detection area and the rear detection area, under the condition that electromagnetic waves are transmitted and received through the second antenna; (iv) a vehicle speed acquisition unit that acquires speed information showing a speed of the vehicle; and (v) a movement judgment unit that judges whether or not a side detection target which is a target detected by the side detection unit is moving based on detection results in the overlap area detected by the rear detection unit and the speed information acquired by the vehicle speed acquisition unit.

According to the radar apparatus, there is a high possibility that the target in the overlap area detected by the rear detection unit is the same target as the side detection target. Therefore, the use of information (relative speed, etc.) detected by the rear detection unit makes it possible to immediately judge whether or not the side detection target is moving.

In the radar apparatus, the movement judgment unit may judge that the side detection target is moving, if a target moving in the overlap area is detected by the rear detection unit.

In this case, the side detection target may inherit information of the target detected by the rear detection unit. Further, it is desirable that a size of the overlap area is set to a size in which a plurality of tracking targets cannot exist at once.

The radar apparatus may further comprise: an overlap area detection unit that detects a target that exists in the overlap area, under the condition that electromagnetic waves are transmitted through the second antenna and are received through the first antenna. The movement judgment unit may control an operation of the overlap area detection unit such that, if the movement judgment unit judges that the side detection target is moving, the side detection target inherits information of the target detected by the overlap area detection unit.

In this case, since the target detected by the overlap area detection unit reliably exists in the overlap area, it is possible to improve reliability of judgment of the movement judgment unit or information inherited by the side detection target or a judgment of the movement judgment unit.

According to a fifth exemplary aspect of the present disclosure, there is provided a radar apparatus mounted on a vehicle, comprising: a first antenna and a second antenna mounted on the vehicle; a rear detection unit that detects a position and relative speed of a target which exists in a rear detection area to the rear of own vehicle, under the condition that electromagnetic waves are transmitted and received through the first antenna; a side detection unit that detects a distance to a target which exists in a side detection area to the side of own vehicle, under the condition that electromagnetic waves are transmitted and received through the second antenna; a movement judgment unit that judges that a side detection target which is a target detected by the side detection unit is moving, if a target is detected in an area having a distance that is regarded as an adjacent traffic lane adjacent to own traffic lane on which own vehicle travels.

It is usually considered that, if the side detection target is a stopped object, a moving object, which is moving on the same traffic lane as the side detection target, needs to travel while passing the side detection target. Due to this, there is a low possibility that a target, which is moving on the adjacent traffic lane at the rear of own vehicle, is detected. In other words, if a moving target exists at the rear of the adjacent traffic lane, there is a high possibility that the target detected is a moving target. Thus, the above judgment of the movement judgment unit becomes effective.

In the radar apparatus the first antenna and the second antenna may be disposed on the same substrate. The first antenna may radiate electromagnetic waves in a direction perpendicular to a pattern-formed plane of the substrate. The second antenna may radiate electromagnetic waves in a direction parallel to the pattern-formed plane.

### BRIEF DESCRIPTION OF THE DRAWINGS

In the accompanying drawings:

FIG. 1 is a block diagram illustrating a general configuration of a radar apparatus according to a first embodiment of the present invention;

FIGS. 2A and 2B are explanatory views illustrating a pattern of a first antenna section and a second antenna section, respectively, formed in an antenna substrate of the radar apparatus;

FIG. 3A is a schematic diagram illustrating a structure of the antenna substrate;

FIG. 3B is an explanatory view illustrating radiation directions of the beams from antenna sections formed in the antenna substrate;

FIGS. 4A to 4D are graphs illustrating modulation patterns of transmission signals of the radar apparatus;

FIG. 5A is a schematic diagram illustrating a configuration of an on-vehicle radar system of the present invention;

FIG. 5B is an explanatory view illustrating an arrangement of antenna substrates in the on-vehicle radar system;

FIG. 6 is a reference diagram illustrating a list of detection modes in the on-vehicle radar system;

FIG. 7 is an explanatory view illustrating approximate positions of blind spot vehicle detection areas and rear approaching vehicle detection areas in the on-vehicle radar system;

FIG. 8 is an explanatory view illustrating approximate positions of blind spot vehicle detection areas and rear crossing vehicle detection areas in the on-vehicle radar system;

FIG. 9 is a flow diagram illustrating a system control process performed in the on-vehicle radar system;

FIG. 10 is a flow diagram illustrating a blind spot vehicle detection warning process performed in the on-vehicle radar system;

FIG. 11 is a flow diagram illustrating a rear approaching vehicle detection warning process performed in the on-vehicle radar system;

FIG. 12 is a flow diagram illustrating a rear crossing vehicle detection warning process performed in the on-vehicle radar system;

FIG. 13 is a flow diagram illustrating a system control process according to a second embodiment of the present invention;

FIGS. 14A and 14B are explanatory views illustrating a modified pattern of a first antenna section and a second antenna section formed on an antenna substrate of a radar apparatus;

FIGS. 15A to 15C are explanatory views illustrating an example of another configuration of second antenna elements;

FIG. 16 is a block diagram illustrating a general configuration of an on-board radar apparatus according to a third embodiment of the present invention;

FIGS. 17A and 17B are explanatory views illustrating a pattern arrangement of the antenna substrate according to the third embodiment;

FIG. 18 is an explanatory view illustrating a rear detection area, a side detection area, and an overlap area according to the third embodiment;

FIG. 19 is a flow diagram illustrating a tracking target inheritance process performed in the on-vehicle radar apparatus according to the third embodiment;

FIG. 20 is a flow diagram illustrating a tracking target inheritance process performed in an on-vehicle radar apparatus according to a fourth embodiment of the present invention;

FIG. 21 is a flow diagram illustrating a tracking target inheritance process performed in an on-vehicle radar apparatus according to a fifth embodiment of the present invention; and

FIG. 22 is an explanatory view according to the fifth embodiment.

### DETAILED DESCRIPTION OF THE PREFERRED EMBODIMENTS

Hereinafter, some embodiments of the present invention are described with reference to the accompanying drawings.

### First Embodiment

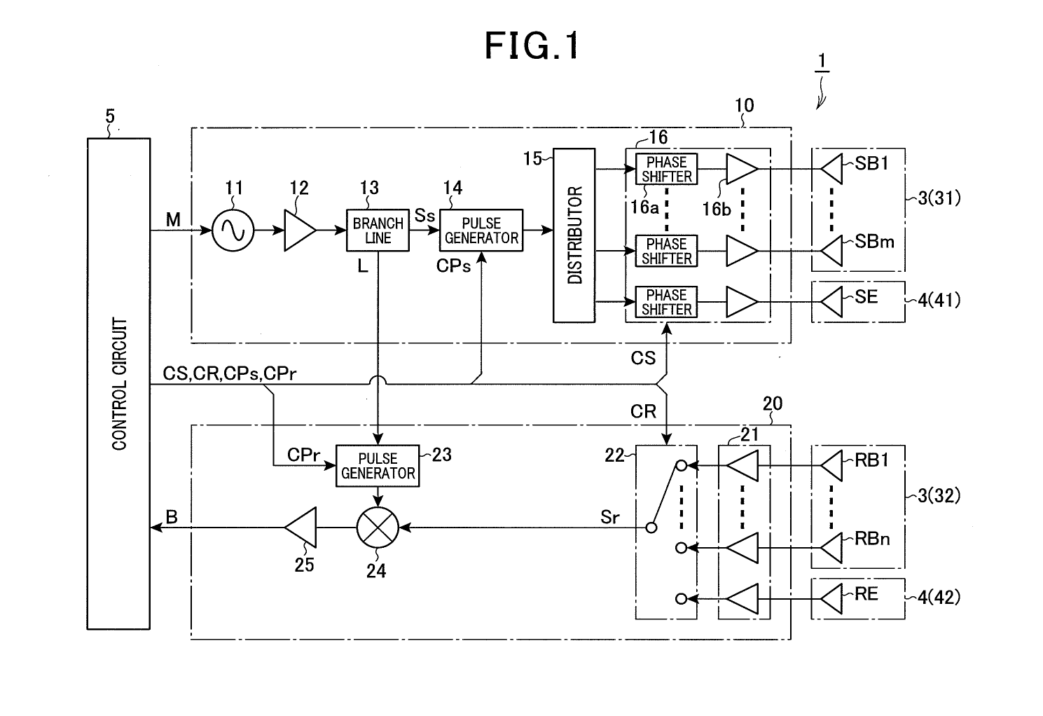

FIG. 1 is a block diagram illustrating a general configuration of a radar apparatus 1 according to a first embodiment of the present invention.

As shown in FIG. 1, the radar apparatus 1 includes a first antenna section 3 (first antenna) and a second antenna section 4 (second antenna). The first antenna section 3 includes a first transmitting antenna group 31 and a first receiving antenna group 32. The first transmitting antenna group 31 is composed of an m (m is an integer of 2 or more) number of first antenna elements SBi (i=1 to m). The first receiving antenna group 32 is composed of an n (n is an integer of 2 or more) number of first antenna elements RBj (j=1 to n). The second antenna section 4 includes a second transmitting antenna 41 composed of a single second antenna element SE and a second receiving antenna 42 composed of a single second antenna element RE. The second antenna section 4 is configured so that the main radiation direction is different from that of the first antenna section 3.

The radar apparatus 1 also includes a transmitter 10, a receiver 20 and a control circuit 5. The transmitter 10 transmits electromagnetic waves (radar waves) via the first transmitting antenna group 31 and the second transmitting antenna 41. The receiver 20 receives electromagnetic waves (reflected waves) via the first receiving antenna group 32 and the second receiving antenna 42. The control circuit 5 is mainly made up of a well-known microcomputer. The control circuit 5 supplies a modulating signal M, transmission control signal CS, reception control signal RC, transmission-side pulse control signal CPs and reception-side pulse control signal CPr, which are described later, to the transmitter 10 and the receiver 20. Resultantly, the control circuit 5 carries out signal processing based on beat signals B generated by the receiver 20.

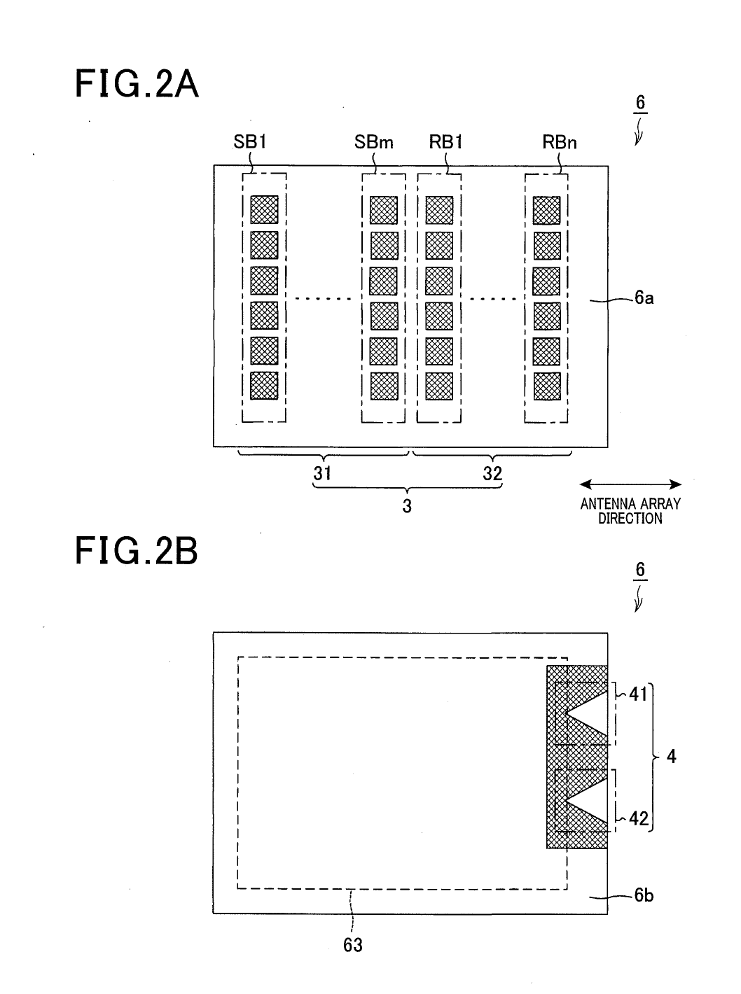

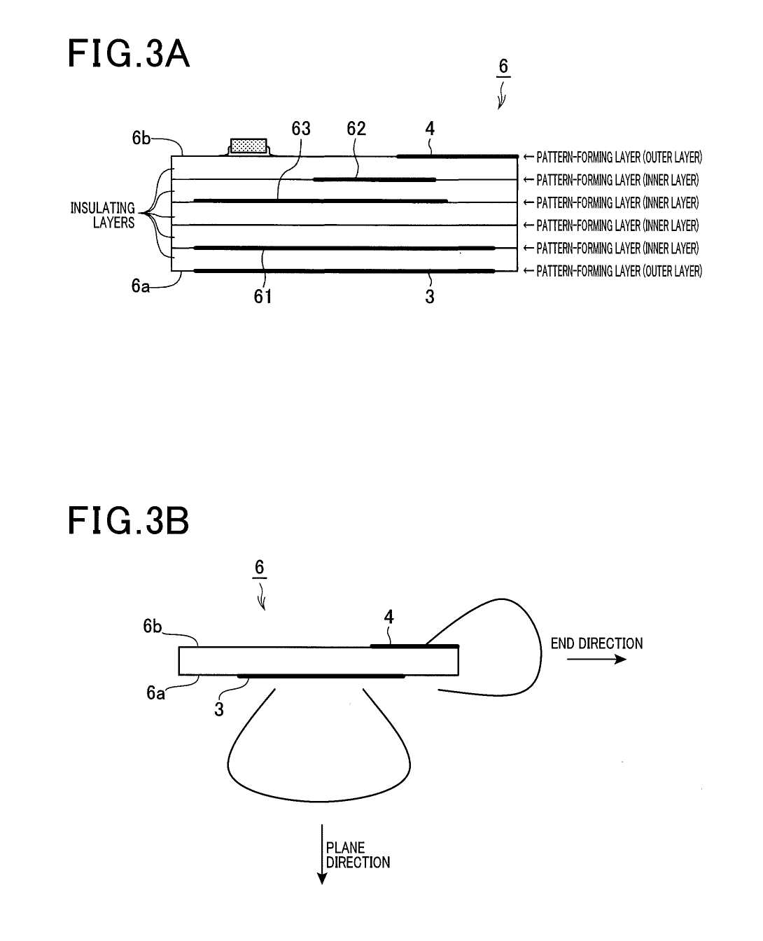

FIG. 2A is an explanatory view illustrating an antenna-formed plane 6a of an antenna substrate 6, in which the first antenna section 3 is formed. FIG. 2B is an explanatory view illustrating a parts-mounted surface 6b of the antenna substrate 6, in which the second antenna section 4 is formed. FIG. 3A is a schematic diagram illustrating a cross section of the antenna substrate 6 being enlarged in the thickness direction of the substrate (vertical direction in the figure). FIG. 3B is an explanatory view illustrating main radiation directions of the antenna sections 3 and 4.

As shown in FIG. 3A, the antenna substrate 6, which is formed of a so-called multilayer board, has six pattern-forming layers and five insulating layers (dielectric bodies) for insulating the pattern-forming layers from each other.

Hereinafter, four pattern-forming layers, in each of which both surfaces contact the respective insulating layers, are referred to as “inner layers”, and two pattern-forming layers, in each of which only one surface contacts the insulating layer and the other surface is exposed to the outside, are referred to as “outer layers”. Further, of the two surfaces of the antenna substrate 6 on which the respective outer layers are formed, one is referred to as the “antenna-formed plane 6a” and the other is referred to as the “parts-mounted surface 6b”.

Of the pattern-forming layers of the antenna substrate 6, an inner layer is formed with a ground pattern 61 used for patch antennas forming the first antenna section 3. This inner layer faces the outer layer provided on the antenna-formed plane 6a, with an insulating layer being interposed therebetween. Further, another inner layer is formed with an electric supply line (microstrip line) 62 that supplies electric power to the second antenna section 4. This inner layer faces the outer layer provided on the parts-formed surface 6b, with an insulating layer being interposed therebetween. Furthermore, still another inner layer is formed with a ground pattern 63 used for the electric supply line (microstrip line) 62. This inner layer is located near the antenna-formed plane 6a so as to face the inner layer in which the electric supply line (microstrip line) 62 is formed, with an insulating layer being interposed therebetween. The ground pattern 63 is formed at a position where the ground pattern 63 faces at least a parts-mounted area of the parts-mounted surface 6b.

As shown in FIG. 2A, in the antenna-formed plane 6a of the antenna substrate 6, the first transmitting antenna group 31 and the first receiving antenna group 32 are arranged side by side, configuring the first antenna section 3. Hereinafter, the direction of array of the antenna groups 31 and 32 is referred to as “antenna array direction”.

As shown in FIG. 2B, in the parts-mounted surface 6b of the antenna substrate 6, the second transmitting antenna 41 and the second receiving antenna 42, which configure the second antenna section 4, are arranged side by side at one end of the antenna substrate 6 with respect to the antenna array direction along a direction perpendicular to the antenna array direction.

The first antenna elements SB1 to SBm forming the first transmitting antenna group 31 and the first antenna elements RB1 to RBn forming the first receiving antenna group 32 are arranged in a row along the antenna array direction.

Each of the first antenna elements SBi and RBj is composed of a plurality of patch antennas which are arranged in a row at equally spaced intervals along a direction (vertical direction in the figure) perpendicular to the antenna array direction. Wiring of the electric supply line is provided so that the patch antennas forming the same antenna element SBi or RBj are supplied with signals of the same phase.

As mentioned above, the patch antennas forming each of the first antenna elements SBi and RBj are arranged in a row here. However, the arrangement is not limited to this one-row arrangement. Alternative to the one-row arrangement, the antenna elements may be arranged in a plurality of rows.

As shown in FIG. 3B, the first antenna section 3 is configured as a so-called “broadside beam array antenna” whose main radiation direction is designed to be a direction (hereinafter referred to as “plane direction”) perpendicular to the antenna-formed plane 6a of the antenna substrate 6.

On the other hand, the second transmitting antenna 41 and the second receiving antenna 42 forming the second antenna section 4 are each made up of a tapered slot antenna that is a pattern having a tapered slot. The tapered slot is formed so that its widely spaced end is open along one side of the antenna substrate 6.

Specifically, as shown in FIG. 3B, the first antenna section 4 is configured as a so-called “end-fire array antenna” whose main radiation direction is designed to be a direction (hereinafter referred to as “end direction”) that is parallel to the parts-mounted surface 6b of the antenna substrate 6 and is perpendicular to the antenna array direction.

The first antenna section 3 and the second antenna section 4 are each designed so that ultra wide band (UWB) modulation will be enabled and that the antenna gain will have a constant value over a wide frequency range.

Referring again to FIG. 1, the transmitter 10 is mainly configured by an oscillator that generates high-frequency signals of a millimeter-wave band. The transmitter 10 includes a voltage controlled oscillator (VCO) 11, amplifier 12, branch line 13, distributor 15, pulse generator 14 and signal controller 16.

The VCO 11 is configured such that its oscillation frequency changes in response to the modulating signal M from the control circuit 5. The amplifier 12 amplifies the output from the VCO 11. The branch line 13 branches the output from the amplifier 12 into a transmission signal Ss and local signal L. The distributor 15 distributes the transmission signal Ss supplied via the branch line 13 to transmission lines connected to the respective antenna elements SB1 to SBm and SE, which form the first transmitting antenna group 31 and the first transmitting antenna 41. The pulse generator 14 generate a pulse signal by electrically connecting and disconnecting the transmission line extending from the branch line 13 to the distributor 15, according to the transmission-side pulse control signal CPs from the control circuit 5. The signal controller 16 controls the amplitude and phase of the transmission signal Ss transmitted via the respective transmission line extending from the distributor 15 to the respective antenna elements SB1 to SBm and SE.

The signal controller 16 includes a plurality of phase shifters 16a and a plurality of amplifiers 16b for each of the transmission lines connected to the respective antenna elements SB1 to SBm and SE. Each amplifier 16b, in particular, is given an amplification factor (gain) set to zero, so that the amplifier 16b also functions as a switch for electrically connecting and disconnecting the corresponding transmission line.

The receiver 20 includes an amplifier 21, reception switch circuit 22, mixer 24, amplifier 25 and pulse generator 23.

The amplifier 21 amplifies the reception signals, on an individual basis, received from the antenna elements RB1 to RBn and RE, which form the first receiving antenna group 32 and the second receiving antenna 42. The reception switch circuit 22 selects any one of the transmission lines connected to the respective antenna elements RB1 to RBn and RE to output a reception signal transmitted via the selected transmission line. The mixer 24 mixes a reception signal Sr from the reception switch circuit 22 with the local signal L transmitted via the branch line 13 to generate beat signals B. The amplifier 25 amplifies the beat signals B outputted from the mixer 24 for supply to the control circuit 5. The pulse generator 23 generates pulse-like local signals L by electrically connecting and disconnecting the transmission line of the local signals L extending from the branch line 13 to the mixer 24, according to the reception-side pulse control signal CPr from the control circuit 5.

The transmitter 10 and the receiver 20 are designed so as to be capable of generating and transmitting pulse signals, i.e. so-called ultra wide band (UWB) modulated pulses, having a pulse width of about 1 nanosecond (ns). Hereinafter are described operation modes of the radar apparatus 1.

In the following description, the operation mode of transmitting and receiving electromagnetic waves via the first antenna section 3 is referred to as “planar radiation mode”. Similarly, the operation mode of transmitting and receiving electromagnetic waves via the second antenna section 4 is referred to as “horizontal radiation mode”. The operation mode that uses pulse waves as electromagnetic waves to be transmitted and received is referred to as “pulse-wave mode”. The operation mode that uses continuous waves (FMCW (frequency modulated continuous wave) or CW (continuous wave)) as electromagnetic waves to be transmitted and received is referred to as “continuous-wave mode”.

The radar apparatus 1 operates according to two operation modes in each of which the planar radiation mode or the horizontal radiation mode is combined with the pulse-wave mode or the continuous-wave mode.

When the operation mode is the planar radiation mode, in the transmitter 10, the amplifiers 16b of the signal controller 16 are controlled in response to the transmission control signal CS such that the transmission signal Ss are supplied only to the first transmitting antenna group 31 (antenna elements SB1 to SBm). At the same time, the phase shifters 16a of the signal controller 16 are controlled such that beams formed by the first transmitting antenna group 31 are directed to the radiation direction specified by the transmission control signal CS.

In the receiver 20, the reception switch circuit 22 is controlled such that any one of the reception signals from the first receiving antenna group 32 (antenna elements RB1 to RBn) is sequentially and repeatedly selected in response to the reception control signal CR, and that sequentially and repeatedly selected reception signals from the antenna elements RB1 to RBn are supplied to the mixer 24 in a time-sharing manner.

When the operation mode is the horizontal radiation mode, in the transmitter 10, the amplifiers 16b of the signal controller 16 are controlled in response to the transmission control signal CS such that the transmission signal Ss are supplied only to the second transmitting antenna 41 (antenna element SE).

In the receiver 20, the reception switch circuit 22 is controlled such that only the reception signals from the second receiving antenna 42 (antenna element RE) are supplied to the mixer 24.

On the other hand, when the operation mode is the continuous-wave mode, the pulse generator 14 of the transmitter 10 and the pulse generator 23 of the receiver 20 both operate in such a way that the transmission signal Ss and the local signal L are passed as they are without being controlled.

When the operation mode is the pulse-wave mode, the pulse generator 14 of the transmitter 10 electrically connects the transmission line extending from the branch line 13 to the distributor 15 for a predetermined time (e.g., 1 nanosecond (ns)) in response to the transmission-side pulse control signal CPs to thereby generate a pulse-like transmission signal Ss. In this case, the transmission line is electrically connected at the predetermined time for a prescribed time interval which is longer than the time required for an electromagnetic wave to travel back and forth the maximum detection distance of the radar apparatus 1.

Further, the pulse generator 23 of the receiver 20 is controlled such that the transmission line extending from the branch line 13 to the mixer 24 is electrically connected for a predetermined time in response to the reception-side pulse control signal CPr to thereby generate a pulse-like local signal L. The pulse-like local signal L is controlled so that it is generated in synchronization with the transmission timing of a pulse wave and that the generation timing is delayed by the time equivalent to the pulse width, every time the transmission of a pulse wave is repeated. The pulse width may be set to a fixed value or may be made variable depending on conditions.

The control circuit 5 operates the transmitter 10 and the receiver 20 in specified operation modes. Under the operation, the control circuit 5 performs a process of detecting a target (target detection process) based on the beat signals B derived from the receiver 20.

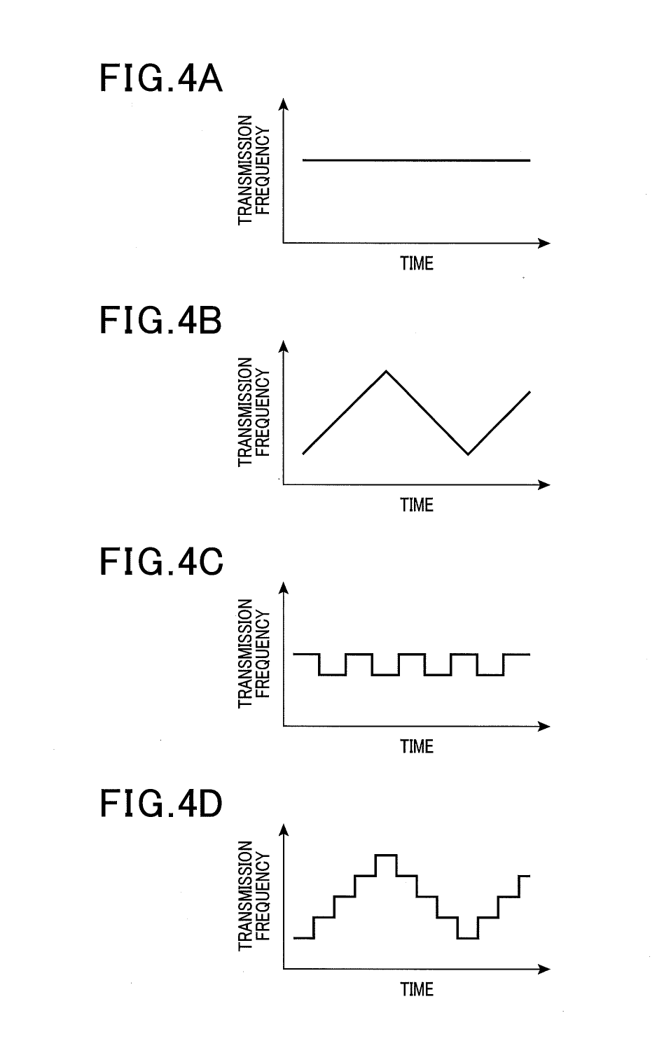

FIGS. 4A to 4D are graphs illustrating modulation patterns of the transmission signals Ss. As shown in FIG. 4A, in the pulse-wave mode, the control circuit 5 supplies a modulating signal M to the VCO 11 to fix the frequency of the transmission signals Ss generated by the VCO 11.

As shown in FIG. 4B, in the continuous-wave mode, the control circuit 5 supplies a modulating signal M to the VCO 11 to generate a triangle-wave-shaped FMCW that repeatedly increases and decreases the frequency of transmission signal Ss generated by the VCO 11. Alternatively, as shown in FIG. 4C, the control circuit 5 supplies a modulating signal M to the VCO 11 to generate dual-frequency CW that alternately switches the frequency of the transmission signal Ss in two stages.

In the pulse-wave mode (in the measurement using pulse waves), the receiver 20 outputs a beat signal B when the reception timing of a pulse wave coincides with the transmission timing of a pulse-like local signal L, the beat signal B having an amplitude suitable for the level of the coincidence. Then, the control circuit 5 performs the target detection process. In the target detection process, the control circuit 5 calculates a distance to the target that has reflected the pulse signal, based on the generation timing of the pulse-like local signal L when a beat signal B having a maximum intensity (correlation value) was obtained. Since this calculation is well known in the art of pulse radar, the details are omitted here.

Specifically, in the pulse-wave mode, the target detection process can provide a distance to the target as information regarding the target present in the detection area.

In the continuous-wave mode (in the measurement using FMCW or dual-frequency CW), the receiver 20 outputs a beat signal B that is the mixture of the reception signal Sr and the local signal L. Then, the control circuit 5 performs the target detection process. In the target detection process, the control circuit 5 calculates a relative speed and distance of the target using a well-known technique in FMCW radar and dual-frequency CW radar.

Specifically, in the continuous-wave mode, the target detection process can provide a relative speed and distance of the target, as information regarding a target present in the detection area.

In the continuous-wave mode, the continuous waves are not limited to FMCW and dual-frequency CW. Instead, the control circuit 5 may output a modulating signal M, as shown in FIG. 4D, for example, to generate multifrequency CW which allows the transmission signals Ss to repeatedly increase and decrease in three or more stages (five stages in the figure) to thereby carry out measurement.

In the planar radiation mode, a beat signal B is obtained for each of the antenna elements RB1 to RBn from the first receiving antenna group 32. Then, the control circuit 5 performs the target detection process. In this process, the control circuit 5 also calculates a direction of arrival of reflected waves, i.e. an orientation angle at which the target is present, based on a phase difference between the beat signals B. In the orientation detection using the phase-difference information, well-known techniques, such as monopulse, DBF (digital beam forming), MUSIC (multiple signal classification), may be used.

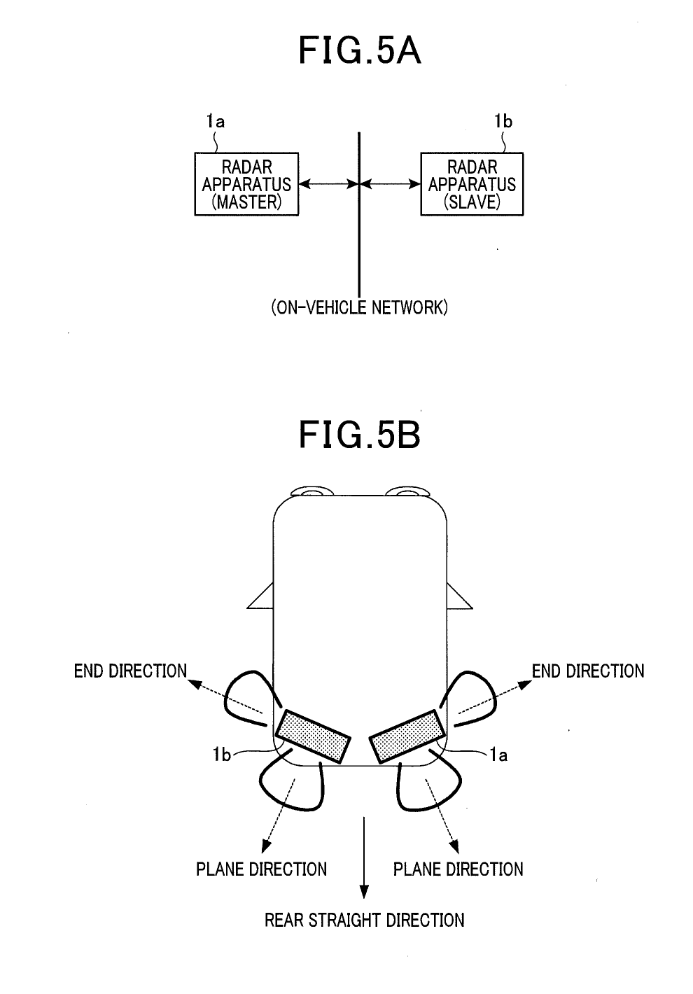

FIG. 5A is a schematic block diagram illustrating an on-vehicle radar system including the radar apparatus 1 described above. FIG. 5B is an explanatory view illustrating an arrangement of the antenna substrates 6 in a vehicle.

As shown in FIG. 5A, the on-vehicle radar system includes two radar apparatuses 1 (1a and 1b). The radar apparatuses 1a and 1b are connected so that they can communicate with each other via an on-vehicle network. It should be appreciated that enabling communication via the on-vehicle network is one of the functions performed by the control circuit 5.

Of the radar apparatuses 1a and 1b, one is a master unit (radar apparatus 1a here) and the other is the slave unit (radar apparatus 1b here). In addition to the target detection process described above, the control circuit 5 of the master unit 1a performs a system control process and a warning process. In the system control process, operation mode and operation timing of both of the radar apparatuses 1a and 1b are controlled. In the warning process, various warnings are given based on the results of the target detection processes performed by both of the radar apparatuses 1a and 1b.

The master unit 1a is configured to supply a signal to the slave unit 1b via the on-vehicle network to control operation mode or operation timing. Further, the master unit 1a is configured to acquire from the slave unit 1b the results of detection obtained through the target detection process. At the same time, the master unit 1a is configured to acquire various pieces of information (e.g., vehicle speed, shift lever position and state of direction indicator) necessary for the processes, from other on-vehicle units connected to the on-vehicle network.

The master-slave communication and communication of the master and slave with other on-vehicle units, here, are performed via the same on-vehicle network. However, these communications may be ensured to be performed via separately provided on-vehicle networks. In this case, the on-vehicle network used for the communication of the master and slave with other on-vehicle units may be connected only to the master unit 1a.

As shown in FIG. 5B, the radar apparatus 1a is arranged at a rear-right corner of the vehicle. In the arrangement, the plane direction of the antenna substrate 6 is fixed being inclined to the left by about 30° with respect to the rear straight direction of the vehicle, as viewed rearward from the vehicle. Thus, the detection area of the first antenna section 3 covers the rear-right direction of the vehicle and the detection area of the second antenna section 4 covers the right side of the vehicle.

On the other hand, the radar apparatus 1b is arranged at a rear-left corner of the vehicle. In the arrangement, the plane direction of the antenna substrate 6 is fixed being inclined to the right by about 30° with respect to the rear straight direction of the vehicle, as viewed rearward from the vehicle. Thus, the detection area of the first antenna section 3 covers the rear-left direction of the vehicle and the detection area of the second antenna section 4 covers the left side of the vehicle.

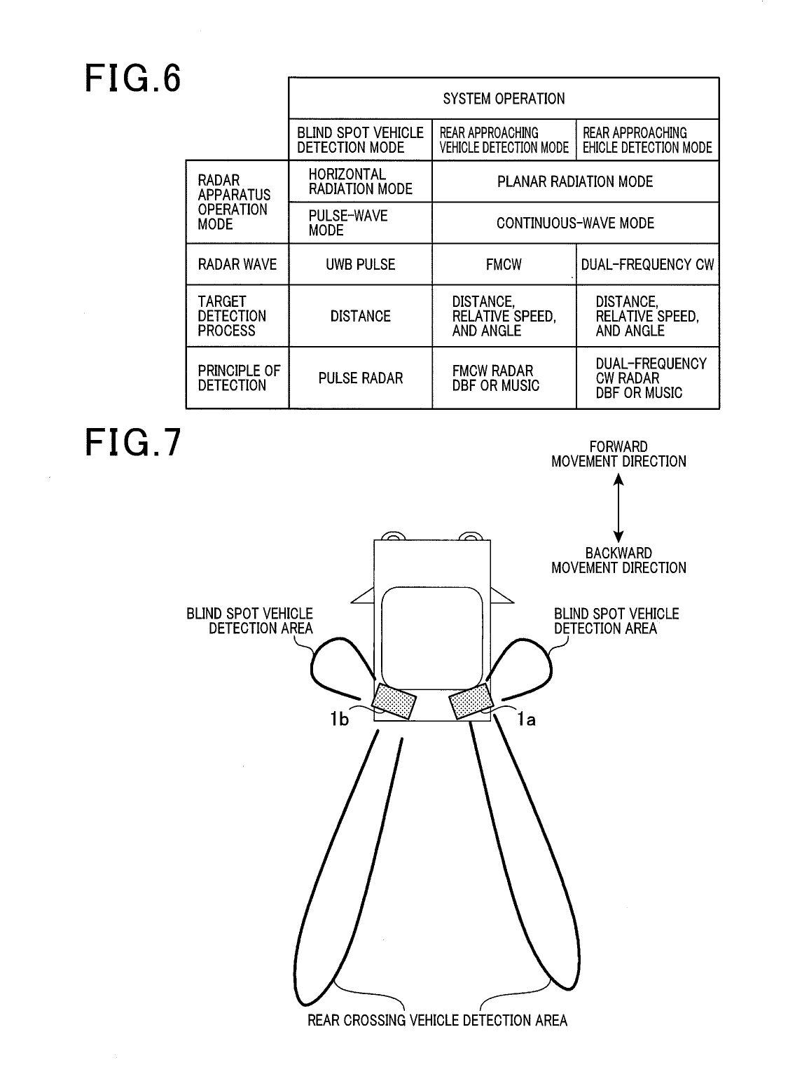

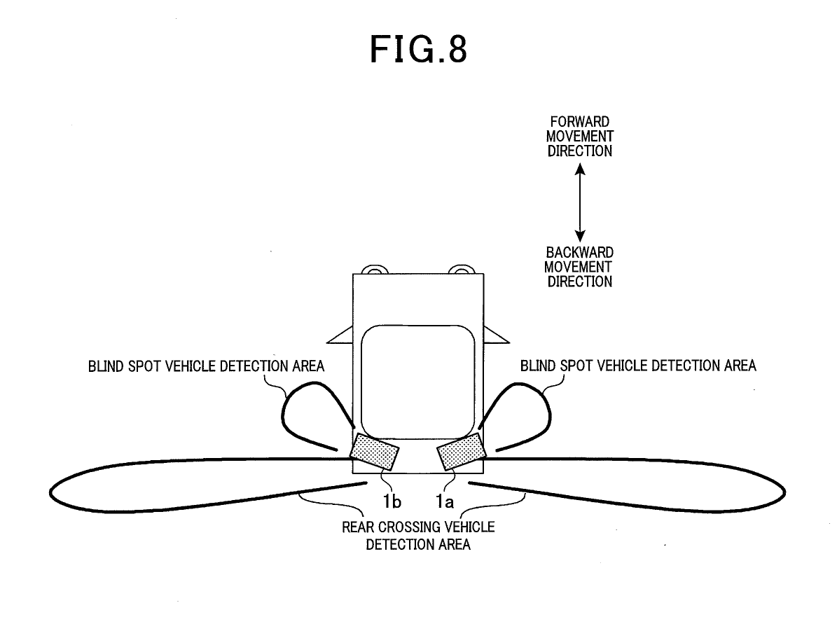

FIG. 6 is a reference diagram illustrating a list of detection modes in the on-vehicle radar system. The detection modes specify how the radar apparatus 1 should be operated when the on-vehicle radar system carries out target detection. FIG. 7 and FIG. 8 are explanatory views illustrating approximate positions of detection areas used in the detection modes.

As shown in FIG. 6, the on-vehicle radar system has: a detection mode in which a vehicle (target) present in a blind spot of the vehicle is detected (hereinafter referred to as “blind spot vehicle detection mode”); a detection mode in which a vehicle (target) approaching from behind is detected (hereinafter referred to as “rear approaching vehicle detection mode”); and a detection mode in which a vehicle (target) on the verge of crossing behind the vehicle during its backward movement is detected (hereinafter referred to as “rear crossing vehicle detection mode”).

Of these detection modes, in the blind spot vehicle detection mode, the radar apparatus 1 is operated in the horizontal radiation mode and the pulse-wave mode. Thus, the control circuit 5 accurately calculates a distance to a target vehicle present in blind spot vehicle detection areas (see FIGS. 7 and 8) created on vehicle sides.

In the rear approaching vehicle detection mode, the radar apparatus 1 is operated in the planar radiation mode and the continuous-wave mode (using FMCW). Thus, the control circuit 5 calculates a distance, relative speed, and orientation angle of a target vehicle present in rear approaching vehicle detection areas (see FIG. 7).

In the rear crossing vehicle detection mode, the radar apparatus 1 is operated in the planar radiation mode and the continuous-wave mode (using dual-frequency CW). Thus, the control circuit 5 calculates a distance, relative speed, and orientation angle of a target vehicle present in rear crossing vehicle detection areas (see FIG. 8).

The rear approaching vehicle detection areas are each fixed centering on the end direction of the antenna substrate 6 so that a target, such as a vehicle, in the adjacent traffic lane can be favorably detected. On the other hand, the rear crossing vehicle detection areas are each fixed centering on a direction greatly inclined from the plane direction toward the end direction of the antenna substrate 6. Thus, a target, such as a vehicle, can be favorably detected at a position comparatively close to the target, covering a broad range in the vehicle's width direction.

Detection areas (directivity of antenna) are different between the rear approaching vehicle detection mode and the rear approaching vehicle detection mode, although both use the first antenna section 3. The different detection areas in these modes are fixed as appropriate by controlling the phase shifters of the signal controller 16.

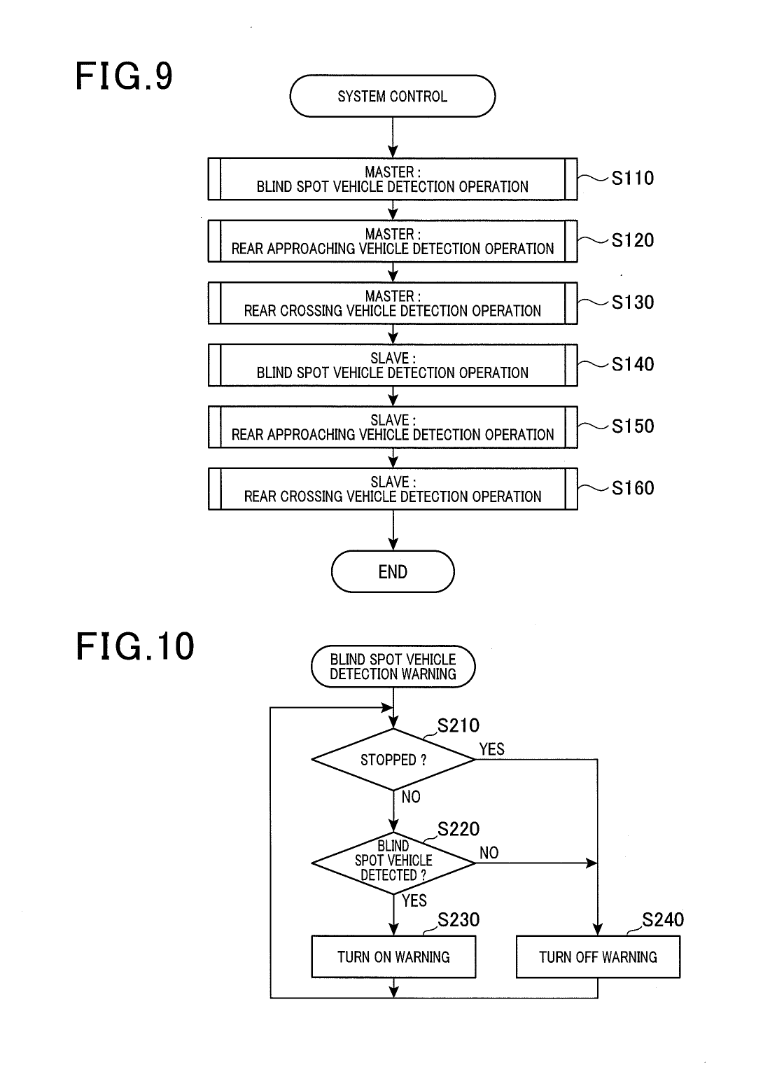

Referring now to FIG. 9, hereinafter is described a system control process performed by the control circuit 5 of the master unit 1a. FIG. 9 is a flow diagram illustrating the system control process.

The system control process is repeatedly performed at every predetermined time interval upon activation of the master unit 1a.

When the system control process is started, at step S110, the master unit 1a is operated in the blind spot vehicle detection mode. Then, the control circuit 5 performs the target detection process according to the results of the measurement in the mode to calculate a distance to a target present in the blind spot vehicle detection area at the right of the vehicle.

At step S120, the master unit 1a is operated in the rear approaching vehicle detection mode. Then, the control circuit 5 performs the target detection process according to the results of the measurement in the mode to calculate a distance, relative speed, and orientation angle of a target present in the rear approaching vehicle detection area at the right of the vehicle.

At step S130, the master unit 1a is operated in the rear approaching vehicle detection mode. Then, the control circuit 5 performs the target detection process according to the results of the measurement in the mode to calculate a distance, relative speed, and orientation angle of a target present in the rear crossing vehicle detection area at the right of the vehicle.

At step S140, the slave unit 1b is operated in the blind spot vehicle detection mode. Then, the control circuit 5 performs the target detection process according to the results of measurement in the mode to calculate a distance to a target present in the blind spot vehicle detection area at the left of the vehicle.

At step S150, the slave unit 1b is operated in the rear approaching vehicle detection mode. Then, the control circuit 5 performs the target detection process according to the results of the measurement in the mode to calculate a distance, relative speed, and orientation angle of a target present in the rear approaching vehicle detection area at the left of the vehicle.

At step S160, the slave unit 1b is operated in the rear approaching vehicle detection mode. Then, the control circuit 5 performs the target detection process according to the results of the measurement in the mode to calculate a distance, relative speed, and an orientation angle of a target present in the rear crossing vehicle detection area at the left of the vehicle.

Hereinafter are described a blind spot vehicle detection warning process, a rear approaching vehicle detection warning process and a rear crossing vehicle detection warning process. These processes are performed based on information regarding a target present in the detection areas, which has been obtained by performing the system control process. These processes are started by the master unit 1a upon activation of the master unit 1a.

Referring to FIG. 10, the blind spot vehicle detection warning process is described first. FIG. 10 is a flow diagram illustrating the blind spot vehicle detection warning process.

When the present process is started, it is determined, at step S210, first, whether or not the vehicle is in a stopped state.

Whether the vehicle is in a stopped state is determined based on the information regarding the vehicle speed and the shift lever position acquired via the on-vehicle network. Specifically, when the vehicle speed is zero and the shift lever is at a parking position, the vehicle is determined as being in a stopped state.

At step S220, it is determined whether or not a vehicle (target) has been detected in the blind spot vehicle detection areas, based on the results of the detection at steps S110 and S140. If it is determined that a target vehicle has been detected, control proceeds to step S230 where the warning is turned on and then control returns to step S210. In giving the warning, a sound mode may be changed according to the distance to the detected target.

On the other hand, if it is determined that a target vehicle has not been detected in the blind spot vehicle detection areas, control proceeds to step S240. At step S240, the warning is turned off if it is in an on-state. If the warning is in an off-state at step S240, no action is taken and control returns to step S210.

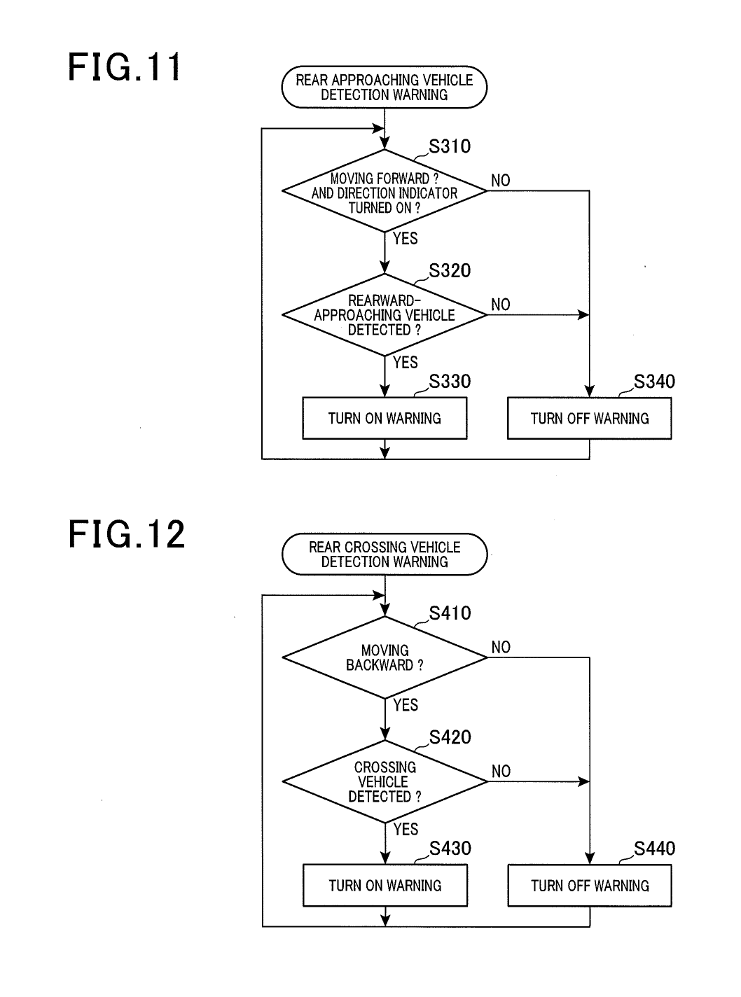

Referring to FIG. 11, the rear approaching vehicle detection warning process is described. FIG. 11 is a flow diagram illustrating the rear approaching vehicle detection warning process.

When the present process is started, it is determined, at step S310, first, whether or not the vehicle is in a state of moving forward and whether or not the direction indicator is turned on.

Whether the vehicle is in a state of moving forward is determined based on the information regarding the vehicle speed and the shift lever position acquired via the on-vehicle network. Specifically, the vehicle is determined as moving forward when the vehicle speed shows a positive value or when the shift lever is at a position of forward movement. Also, the state of the direction indicator is acquired via the on-vehicle network.

If an affirmative determination is made at step S310, control proceeds to step S320. At step S320, it is determined whether or not a vehicle (target) has been detected in the rear approaching vehicle detection areas, based on the results of the detection at steps S120 and S150. If it is determined that a target vehicle has been detected, control proceeds to step S330 where the warning is turned on and control returns to step S310. In giving the warning, the sound mode may be changed according to a distance, relative speed, and orientation angle of a detected target.

On the other hand, if it is determined that no target vehicle has been detected, control proceeds to step S340. At step S340, the warning is turned off if it is in an on-state. If the warning is in an off-state at step S340, no action is taken and control returns to step S310.

Referring to FIG. 12, the rear crossing vehicle detection warning process is described. FIG. 12 is a flow diagram illustrating the rear crossing vehicle detection warning process.

When the present process is started, it is determined, at step S410, first, whether or not the vehicle is in a state of moving backward.

Whether the vehicle is in a state of moving backward is determined based on the information regarding the vehicle speed and the shift lever position acquired via the on-vehicle network. Specifically, the vehicle is determined as moving backward when the vehicle speed shows a negative value or when the shift lever is at a position of backward movement.

If an affirmative determination is made at step S410, control proceeds to step S420. At step S420, it is determined whether or not a vehicle (target) has been detected in the rear crossing vehicle detection areas. If it is determined that a target vehicle has been detected, control proceeds to step S430 where the warning is turned on and control returns to step S410. In giving the warning, the sound mode may be changed according to the distance, relative speed, and orientation angle of a detected target.

On the other hand, if it is determined that a target vehicle has not been detected in the rear crossing vehicle detection areas, control proceeds to step S440. At step S440, if the warning is in an on-state, the warning is turned off. If the warning is in an off-state at step S440, no action is taken and control returns to step S410.

As described above, the radar apparatus 1 includes the first antenna section 3 whose main radiation direction is the plane direction of the antenna substrate 6, and the second antenna section 4 whose main radiation direction is the end direction of the antenna substrate 6. The antenna sections 3 and 4 are formed in different pattern-forming layers of the antenna substrate 6. Therefore, compared with the case where both of the antenna sections 3 and 4 are formed in the same pattern-forming layer, radiation of the second antenna section 4 can be farther directed toward the rear surface opposite to the surface in which the first antenna section 3 is formed. As a result, the detection area that can be covered by the single antenna substrate 6 is widely angled (e.g., 180° or more).

### Second Embodiment

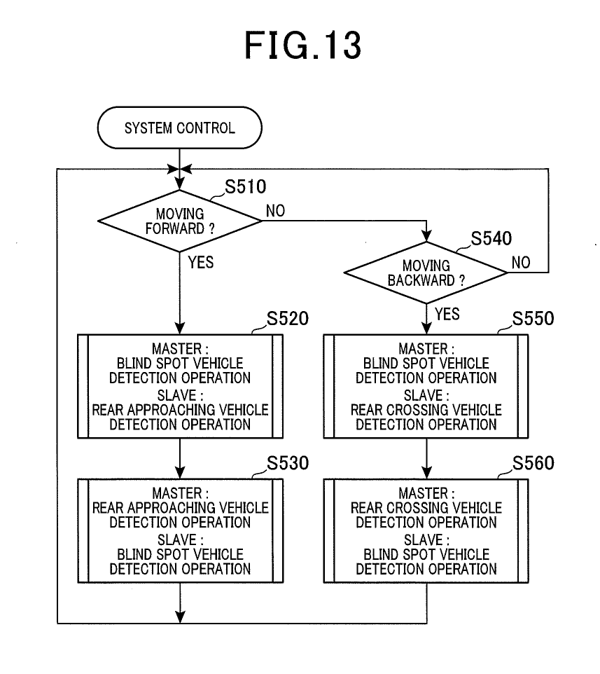

With reference to FIG. 13, hereinafter is described a second embodiment of the present invention. In the second embodiment as well as in the modifications described later, the components identical with or similar to those in the first embodiment are given the same reference numerals for the sake of omitting unnecessary explanation.

The second embodiment is different from the first embodiment in the system control process performed by the radar apparatus 1a that is the master unit. Therefore, the second embodiment is described focusing on the difference.

FIG. 13 is a flow diagram illustrating a system control process according to the second embodiment.

When the system control process is started, it is determined, at step S510, first, whether or not the vehicle is in a state of moving forward. Whether the vehicle is in a state of moving forward is determined in a manner similar to step S310.

If the vehicle is in a state of moving forward, control proceeds to step S520. At step S520, the master unit 1a is operated in the blind spot vehicle detection mode, while the slave unit 1b is operated in the rear approaching vehicle detection mode.

At the subsequent step S530, the modes are reversed from the modes at step S520. Specifically, the master unit 1a is operated in the rear approaching vehicle detection mode, while the slave unit 1b is operated in the blind spot vehicle detection node. After that, control returns to step S510.

At step S510, if the vehicle is determined not being in a state of moving forward, control proceeds to step S540. At step S540, it is determined whether or not the vehicle is in a state of moving backward. If the vehicle is not in a state of moving backward, control returns to step S510. Whether the vehicle is in a state of moving backward is determined in a manner similar to step S410.

At step S540, if the vehicle is determined as being in a state of moving backward, control proceeds to step S550. At step S550, the master unit 1a is operated in the blind spot vehicle detection mode, while the slave unit 1b is operated in the rear approaching vehicle detection mode.

At the subsequent step S560, the modes are reversed from the modes at step S550. Specifically, the master unit 1a is operated in the rear approaching vehicle detection mode, while the slave unit 1b is operated in the blind spot vehicle detection mode. After that, control returns to step S510.

In the on-vehicle control system configured in this way, two radar apparatuses (master unit and slave unit) 1a and 1b are simultaneously operated. Therefore, target detection is efficiently performed.

Moreover, the detection modes of the radar apparatuses 1a and 1b are combined in such a way that the antenna section to be used (or further, the area to be detected) and the type of radar waves (pulse wave or continuous wave) used for detection will be necessarily different between the two units. For this reason, interference is prevented from occurring between the radar apparatuses 1a and 1b.

### (Modifications)

The first and second embodiments have been described so far. However, the present invention is not limited to these embodiments described above but may be implemented in various modes within a scope not departing from the spirit of the present invention.

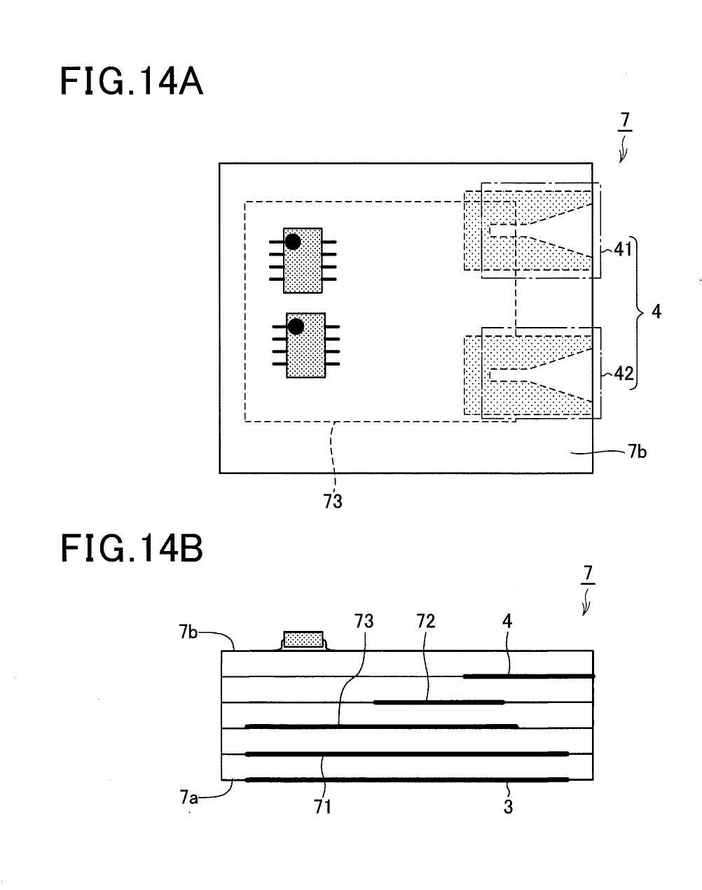

In the embodiments described above, the antenna substrate 6 has the second antenna section 4 which is formed in the parts-mounted surface 6b (outer layer). Alternative to this, an antenna substrate 7, as shown in FIGS. 14A and 14B, may be used, in which the second antenna section 4 is formed in a pattern-forming layer (inner layer) so as to face a parts-mounted surface 7b with one insulating layer being interposed therebetween.

FIG. 14A is a plan view illustrating the antenna substrate 7 as viewed from the parts-mounted surface 7b. FIG. 14B is a cross-sectional view illustrating the antenna substrate 7.

As shown in FIGS. 14A and 14B, in the antenna substrate 7, the first antenna section 3 is formed in an antenna-formed plane 7a, similar to the antenna substrate 6. Further, a ground pattern 71 for the first antenna section 3 is formed in a pattern-forming layer (inner layer) so as to face the antenna section 3, to which electric power is supplied, with one insulating layer being interposed therebetween. Similarly, an electric supply line (microstrip line) 72 for the second antenna section 4 is formed in a pattern-forming layer (inner layer) so as to face the antenna section 4, to which electric power is supplied, with one insulating layer being interposed therebetween. Furthermore, a ground pattern 73 for the electric supply line 72 is positioned near the antenna-formed plane with respect to the inner layer in which the electric supply line 72 is formed. The ground pattern 73 is formed so as to face the electric supply line 72, with one insulating layer being interposed therebetween.

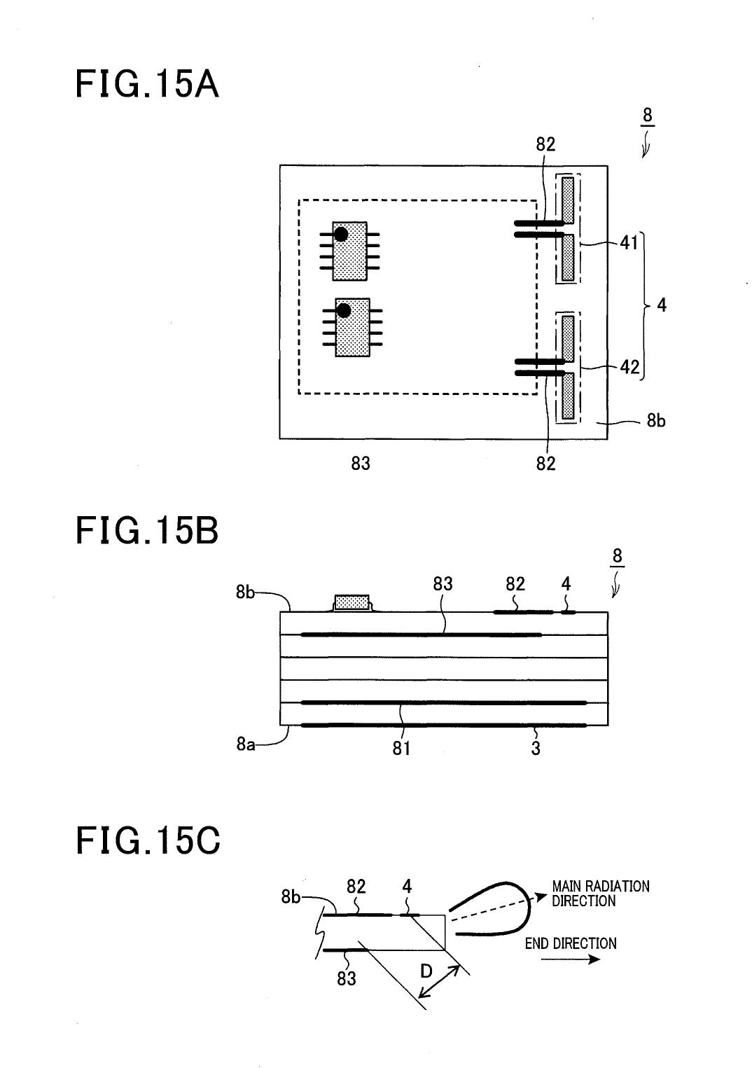

In the embodiments described above, tapered slot antennas have been used as the second antenna elements SE and RE forming the second antenna section 4. Alternative to this, dipole antennas, as shown in FIGS. 15A to 15C, which are formed by patterning may be used.

FIG. 15A is a plan view of an antenna substrate 8 as viewed from a parts-mounted surface 8b. FIG. 15B is a cross-sectional view illustrating the antenna substrate 8. FIG. 15C is an explanatory view illustrating a relationship between an electric supply line and the dipole antennas.

As shown in FIGS. 15A to 15C, the first antenna section 3 is formed in the antenna-formed plane 8a (outer layer) of the antenna substrate 8, similar to the antenna substrate 6. Further, a ground pattern 81 for the first antenna section 3 is formed in a pattern-forming layer (inner layer) so as to face the antenna-formed plane 8a, with one insulating layer being interposed therebetween.

On the other hand, a parts-mounted surface 8b of the antenna substrate 8 is formed not only with the first antenna section 4, but also with an electric line (microstrip line) 82 for the second antenna section 4. Further, a ground pattern 83 for the electric line 82 is formed in a pattern-forming layer (inner layer) so as to face the parts-mounted surface 8b, with one insulating layer being interposed therebetween.

As shown in FIG. 15C, at the electric supply end of the electric supply line 82, the ground pattern 83 is omitted. Here, the ground pattern 83 and the second antenna section 4 are formed such that a distance D between the right end (as viewed in the figure) of the ground pattern 83 and the second antenna section 4 will be approximately equal to a ¼ wavelength of an electromagnetic wave to be transmitted and received.

Thus, in the antenna substrate 8, the second antenna section 4 and the electric supply line 82 are formed so as to ensure the distance D between the second antenna section 4 and the ground pattern 83. The antenna substrate 8 configured in this way is able to enhance the antenna gain. In addition, the antenna substrate 8 is able to shift the main radiation direction (orientation of the beams) of the second antenna section 4 from the end direction toward the parts-mounted surface 8b of the antenna substrate 8.

In the embodiments described above, detection modes of the on-vehicle radar system have been provided by combining operation modes, i.e. combining the planar radiation mode with the continuous-wave mode, or combining the horizontal radiation mode with the pulse-wave mode. However, combinations of the operation modes are not limited to these combinations. For example, the planar radiation mode may be combined with the pulse-wave mode, or the horizontal radiation mode may be combined with the continuous-wave mode.

### Third Embodiment

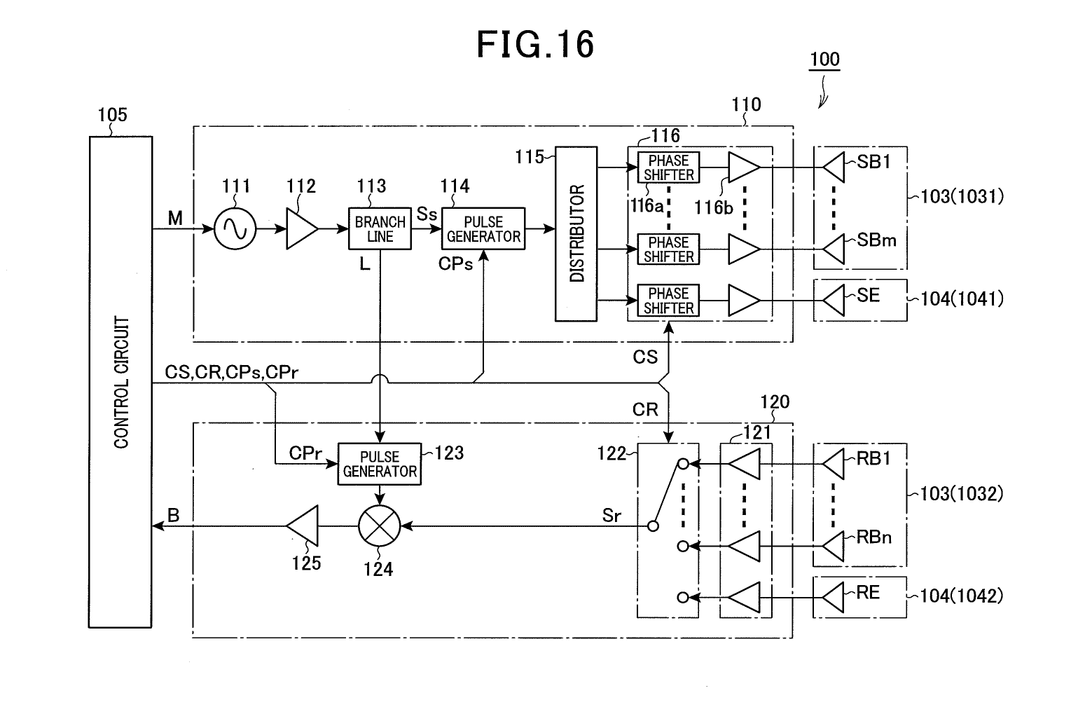

FIG. 16 is a block diagram illustrating a general configuration of a radar apparatus 101 according to a third embodiment of the present invention.

As shown in FIG. 16, the radar apparatus 101 includes a first antenna section 103 (first antenna) and a second antenna section 104 (second antenna). The first antenna section 103 includes a first transmitting antenna group 1031 and a first receiving antenna group 1032. The first transmitting antenna group 1031 is composed of an m (m is an integer of 2 or more) number of first antenna elements SBi (i=1 to m). The first receiving antenna group 32 is composed of an n (n is an integer of 2 or more) number of first antenna elements RBj (j=1 to n). The second antenna section 104 includes a second transmitting antenna 1041 made up of a single second antenna element SE and a second receiving antenna 1042 made up of a single second antenna element RE. The second antenna section 104 is configured so that the main radiation direction is different from that of the first antenna section 103.

The radar apparatus 101 also includes a transmitter 110, a receiver 120 and a control circuit 5. The transmitter 110 transmits electromagnetic waves (radar waves) via the first transmitting antenna group 1031 and the second transmitting antenna 1041. The receiver 120 receives electromagnetic waves (reflected waves) via the first receiving antenna group 1032 and the second receiving antenna 1042. The control circuit 105 is mainly composed of a well-known microcomputer. The control circuit 5 supplies a modulating signal M, transmission control signal CS, reception control signal RC, transmission-side pulse control signal CPs and reception-side pulse control signal CPr, which are described later, to the transmitter 10 and the receiver 120. Resultantly, the control circuit 5 carries out signal processing based on beat signals B generated by the receiver 120.

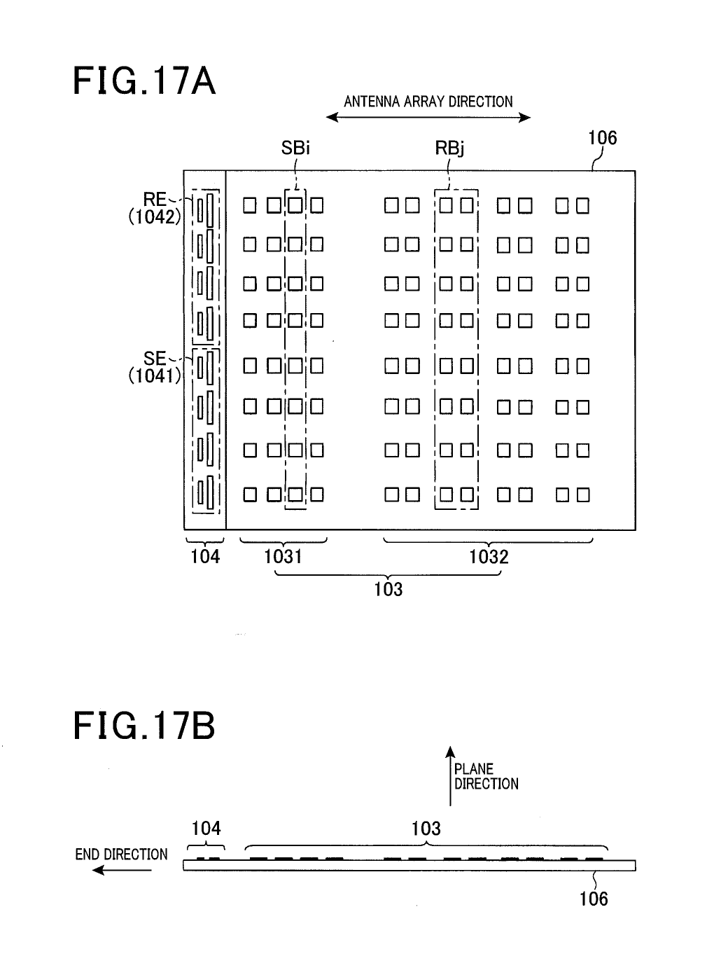

FIGS. 17A and 17B show an arrangement of a pattern on the antenna substrate 106 on which the first antenna section 103 and the second antenna section 104 are formed. FIG. 17A is a front view and FIG. 17B is a side view, where m=n=4.

As shown in FIGS. 17A and 17B, the first transmitting antenna group 1031 and the first receiving antenna group 1032 included in the first antenna section 103 are arranged side by side on the antenna substrate 106, and the second antenna section 104 is arranged at one side of the antenna substrate 106 which lies in the opposite side across the first transmitting antenna group 1031 from the first receiving antenna group 1032.

Each of the antenna elements SBi of the first transmitting antenna group 1031 and each of the antenna elements RBj of the first receiving antenna group 1032 are arrayed in a row along a direction (hereinafter, referred to as “antenna array direction”) of an array of the first transmitting antenna group 1031, the first receiving antenna group 1032, and the second antenna section 104.

The antenna elements SBi are composed of a plurality of patch antennas which are arranged in a row at equally spaced intervals along a direction (vertical direction in the figure) perpendicular to the antenna array direction. The antenna elements RBj are composed of a plurality of patch antennas which are arranged in two rows at equally spaced intervals along a direction perpendicular to the antenna array direction.

That is, the first antenna section 103 is configured as a so-called “broadside beam array antenna” whose main radiation direction is designed to be a direction (hereinafter referred to as “plane direction”) perpendicular to a pattern-formed plane of the antenna substrate 106.

In the second antenna section 104, the second transmitting antenna 1041 and the second receiving antenna 1042 are arranged along a direction a perpendicular to the antenna array direction. Here, the second transmitting antenna 1041 and the second receiving antenna 1042 are configured, as a so-called “end-fire array antenna”, in such a manner that a plurality of Yagi antennas, each whose main radiation direction is designed to be a direction (hereinafter referred to as “end direction”) that is parallel to the pattern-formed plane of the antenna substrate 106 and is perpendicular to a forming-end of the first antenna section 1041, are arranged along a forming-end of the second antenna section 4.

Among the plurality of patch antennas and the plurality of Yagi antennas, a plurality of sets of antennas that includes the same antenna elements SBi, RBi, SE and RE are wired to transmit/receive signals of the same phase.

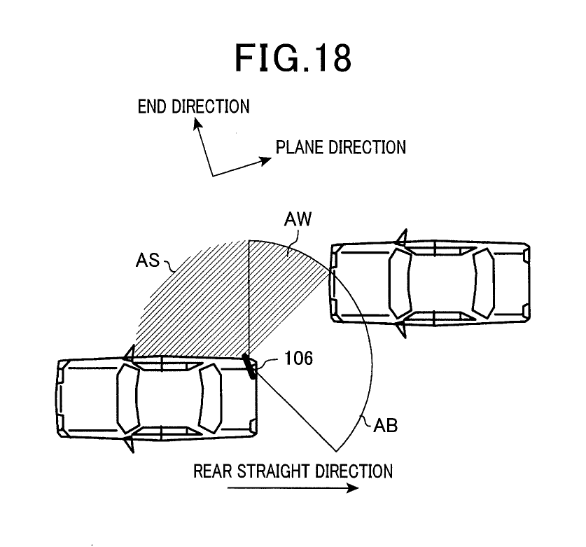

The above-configured antenna substrate 106 is arranged, as shown in FIG. 18, such that it coincides with the above plane direction of the antenna substrate 106 and the antenna array direction coincides with a direction (horizontal direction) parallel to a roadway surface, and is used as a radar apparatus that detects a following vehicle, which is following own vehicle and is running on a right-hand traffic lane (hereinafter referred to as “right-hand adjacent lane”) adjacent to a traffic lane on which own vehicle is running, and a vehicle which is running on the right-hand adjacent lane side by side with own vehicle.

Specifically, a detection area (hereinafter referred to as “rear detection area”) AB of the first antenna section 103 is designed to cover an area ranging within ±about 60° (total about 120°) with respect to the center of a direction (the plane direction of the antenna substrate 106) that tilts at about 30° from a rear straight direction of the vehicle. A detection area (hereinafter referred to as “side detection area”) AS of the second antenna section 104 is designed to cover an area ranging within ±about 60° (total about 120°) with respect to the center of a direction (the end direction of the antenna substrate 106) that tilts toward the front of the vehicle at about 90° from a direction of a central axis of the rear detection area AB.

In other words, the rear detection area AB and the side detection area AS are designed to be partially-overlapped (about 30°) with each other. Hereinafter, this partially-overlapped area between the rear detection area AB and the side detection area AS is referred to as an “overlap area AW”.

Further, an operation mode in which a target present in the rear detection area AB is detected using the first antenna section 103 is referred to as a “rear detection mode”, and an operation mode in which a target present in the side detection area AS is detected using the second antenna section 104 is referred to as a “side detection mode”.

Referring again to FIG. 16, the transmitter 110 is mainly configured by an oscillator that generates high-frequency signals of a millimeter-wave band. The transmitter 110 includes a voltage controlled oscillator (VCO) 111, amplifier 112, branch line 113, distributor 115, pulse generator 114 and signal controller 116.

The VCO 111 is configured such that its oscillation frequency changes in response to the modulating signal M from the control circuit 105. The amplifier 112 amplifies the output from the VCO 111. The branch line 113 branches the output from the amplifier 112 into a transmission signal Ss and local signal L. The distributor 115 distributes the transmission signal Ss supplied via the branch line 113 to transmission lines connected to the respective antenna elements SB1 to SBm and SE, which form the first transmitting antenna group 1031 and the first transmitting antenna 1041. The pulse generator 114 generates pulse signals by electrically connecting and disconnecting the transmission line extending from the branch line 113 to the distributor 115, according to the transmission-side pulse control signal CPs from the control circuit 105. The signal controller 116 controls the amplitude and phase of the transmission signal Ss transmitted via the respective transmission line extending from the distributor 115 to the respective antenna elements SB1 to SBm and SE.

The signal controller 116 includes a plurality of phase shifters 116a and a plurality of amplifiers 116b for each of the transmission lines connected to the respective antenna elements SB1 to SBm and SE. In the signal controller 116, when the operation mode is the rear detection mode, the amplifiers 116b are controlled in response to the transmission control signal CS such that the transmission signal Ss is supplied to the antenna elements SB1 to SBm (the first transmitting antenna group 1031). At the same time, the phase shifters 116a are controlled such that beams formed by the first transmitting antenna group 31 are directed to the radiation direction specified. On the other hand, when the operation mode is the side detection mode, the amplifiers 116b are controlled in response to the transmission control signal CS such that the transmission signal Ss is supplied to the antenna elements SE (the second transmitting antenna group 1041).

Further, when the operation mode is the rear detection mode, the pulse generator 114 operates such that the transmission signal Ss is passed without any changes. On the other hand, when the operation mode is the side detection mode, the pulse generator 114 operates such that an electric pass from the branch line 113 to the distributor 115 is electrically opened and closed in response to the pulse control signal CPs to thereby generate a pulse signal of a short pulse width (e.g., about 1 nanosecond (ns) in the present embodiment) used for ultra wide band (UWB) modulation.

The receiver 120 includes an amplifier 121, reception switch circuit 122, mixer 124, amplifier 125 and pulse generator 123.

The amplifier 121 amplifies the reception signals, on an individual basis, received from the antenna elements RB1 to RBn and RE, which form the first receiving antenna group 1032 and the second receiving antenna 1042. The reception switch circuit 122 selects any one of the transmission lines connected to the respective antenna elements RB1 to RBn and RE to output a reception signal transmitted via the selected transmission line. The mixer 124 mixes reception signal Sr from the reception switch circuit 122 with the local signal L transmitted via the branch line 113 to generate a beat signal B. The amplifier 125 amplifies the beat signal B outputted from the mixer 124 for supply to the control circuit 105. The pulse generator 123 generates a pulse-like local signal L by electrically connecting and disconnecting the transmission line of the local signal L extending from the branch line 113 to the mixer 124, according to the reception-side pulse control signal CPr from the control circuit 105.

When the operation mode is the rear detection mode, the reception switch circuit 122 is controlled such that any one of the reception signals from the antenna elements RB1 to RBn (first receiving antenna group 1032) is sequentially and repeatedly selected in response to the reception control signal CR. On the other hand, when the operation mode is the side detection mode, the reception switch circuit 122 is controlled such that only the reception signal from the antenna element RE (second receiving antenna 1042) is selected in response to the reception control signal CR.

Further, when the operation mode is the rear detection mode, the pulse generator 123 operates such that the local signal L is passed without any changes. On the other hand, when the operation mode is the side detection mode, the pulse generator 123 operates such that an electric path from the branch line 113 to the mixer 124 is electrically opened and closed in response to the pulse control signal CPs to thereby generate a pulse signal of a desired pulse width (e.g., about 1 nanosecond (ns) in the present embodiment).

The control circuit 105 controls the operation mode to alternately switch between the rear detection mode and the side detection mode to perform processes including (i) a target detection process to detect a target in each of the rear detection area AB and the side detection area AS, (ii) a tracking process to extract a moving target from targets detected at the target detection process and to track the moving target in each of the rear detection area AB and the side detection area AS, and (iii) a movement judgment process to judge whether or not the target detected in the side detection area AS is moving.

The control circuit 105 is configured to obtain speed information representing a vehicle speed (own vehicle speed) from a vehicle with the radar apparatus 101. The speed information may be obtained via an on-board network such as CAN (controller area network) mounted on the vehicle.

Among these processes, first, the target detection process is described below. In this process, the transmitter 110 and the receiver 120 are controlled to be operated as FMCW radar in the rear detection mode and as pulse radar using a UMB modulation in the side detection mode.

Specifically, in the rear detection mode, the signal controller 116 is controlled to supply, to the VCO 111, a triangle-wave-shaped modulating signal M for a modulation to repeat a straight gradual increase and decrease in frequency with time, and to radiate FMCW toward the rear detection area AB through the first transmitting antenna group 1031 based on the transmission control signal CS. Here, setting of the phase shifters 116a is changed each one period of the modulating signal M, and then, radiation direction of beams is sequentially changed to enable for beams to be scanned in the rear detection area AB.

At the same time, in the receiver 120, the reception switch circuit 122 is controlled such that reception signals from the first receiving antenna group 1032 are supplied to the mixer 124 in a time-sharing manner, and therefore, the control circuit 105 inputs signal level of beat signal B from the receiver 120 through an A/D (analog/digital) conversion process. A switch operation of the reception switch circuit 122 is performed at such a rate that can obtain data which has the number of data needed to perform a frequency analysis process in the target detection process during one period of the modulating signal M, while synchronizing with the modulating signal M.

On the other hand, in the target detection process, the frequency analysis process for the beat signal B obtained each the antenna element RBj of the first reception antenna group 1032 is performed and therefore, a distance and relative speed of a target are calculated by using a well-known technique in the FMCW radar. At the same time, an orientation in which the target exists is detected based on a phase difference between beat signals B that are generated because each antenna element RBj of the first reception antenna group 1032 is different in position in the horizontal direction from one another.

According to the target detection process, as information regarding a target that exists in the rear detection area AB, at least a position (distance, orientation) and relative speed of the target are obtained.

Then, the side detection process is described below. In this process, the modulating signal M of a prescribed signal level is supplied to the VCO 111 such that the transmission signals Ss of a prescribed frequency are generated, and a pulse-like signal is generated by electrically connecting the transmission line from the branch line 113 to the distributor 115, according to the pulse control signal CPs at a prescribed time interval that is set to a time longer than a time required for electromagnetic waves to travel back and forth the maximum detection distance of the radar apparatus 101.

At the same time, in the receiver 120, the reception switch circuit 122 is controlled such that the reception signal from the second receiving antenna 142 is supplied to the mixer 124 based on the reception control signal CR. Further, the pulse generator 123 is controlled such that, each time pulse waves are transmitted, a pulse-like local signal of the same pulse width is generated. The pulse-like local signal L is controlled such that it is generated in synchronization with the transmission timing of pulse waves and that the generation timing is delayed by the time equivalent to the pulse width, every time the transmission of pulse waves is repeated.

Here, when the transmission waves and the reception waves are overlapped with each other, the beat signal B is generated. Due to this, a distance to the target that has reflected the pulse signal is calculated based on the generation timing of the pulse-like local signal L when the beat signal B having a maximum intensity (correlation value) was obtained. This target distance calculation process is well-known for the pulse radar.

According to the side detection mode, as information regarding a target that exists in the side detection area AS, a distance to the target is obtained.

Then, the tracking process is described below. This process is performed for the rear detection area AB and the side detection area AS, independently. In the tracking process for the rear detection area AB, among targets detected in in the rear detection mode, a target having a speed (a target having relative speed≠own vehicle speed) is regarded as a tracking target. Then, a target, which is estimated as the same as the tracking target on the basis of information (position and relative speed) obtained from the tracking target, is tracked in a time sequential order. Such a target tracking based on its position and relative speed is well-known technique in the on-board radar apparatus and then its detailed explanation is omitted.

On the other hand, in the tracking process for the side detection area AS, as information regarding the target, a distance is obtained with a high degree of accuracy. However, only distance information makes it difficult to judge whether or not the target is a moving target to be tracked, e.g., whether the target is a vehicle or a side wall such as a guardrail. Therefore, by a moving judgment process using detection results of the rear detection mode and the antenna apparatus which is described below, a tracking process for a target, which is judged to be a target is moving in the side detection area, is performed.

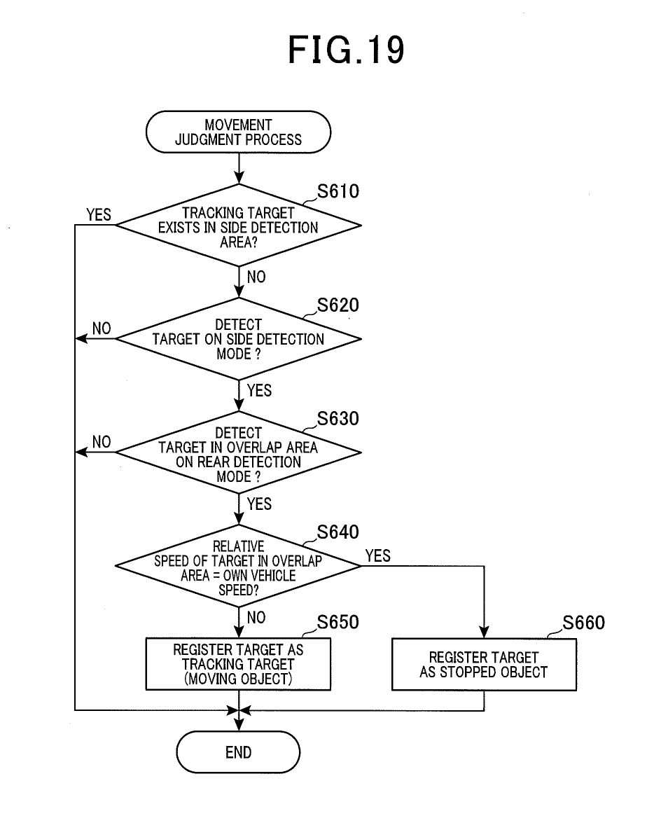

Finally, hereinafter, the movement judgment process is described in detail with reference to a flowchart shown in FIG. 19. This process is started, each time process results of the target detection process are obtained based on detection results of both operation mode (i.e., rear detection mode and side detection mode).

On the start of the movement judgment process, the control circuit 105 judges whether or not a target that is being tracked in the side detection area AS exists (step S610). As a result, if the target that is being tracked exists (YES in step S610), the control circuit 105 completes the process. If the target that is being tracked does not exist (NO in step S610), the control circuit 105 judges whether or not a target is detected by the target detection process based on detection results of the side detection mode (step S620). As a result, if the target is not detected (NO in step S620), the control circuit 105 completes the process. Hereinafter, a target, which is detected based on the detection results of the side detection mode, is referred to as a “side detection target”.

Then, if the side detection target is detected (YES in step S620), the control circuit 105 judges whether or not a target is detected in the overlap area AW by the target detection process based on detection results of the rear detection mode (step S630). As a result, if the target is not detected in the overlap area AW (NO in step S630), the control circuit 105 completes the process.

Then, if the target is detected in the overlap area AW (YES in step S630), the control circuit 105 judges whether or not the target is a stopped object based on whether or not the relative speed of the target coincides with own vehicle speed (step S640). As a result, if the target detected in the overlap area AW is a stopped object (YES in step S640), the control circuit 105 resisters the side detection target as the stopped object in e.g., a memory (not shown) of the control circuit 105 (step S660), and subsequently completes the process.

If the target detected in the overlap area AW is not a stopped object (NO in step S640), the control circuit 105 registers the side detection target as a tracking target (i.e., moving target) in the side detection area AS in e.g., a memory (not shown) of the control circuit 105, and enables the registered side detection target to inherit information (position, relative speed, etc.) of the target, which is detected in the overlap area AW based on results of the rear detection area (step S650), and then completes the process.

As described above, in the radar apparatus 101 according to the present embodiment, if the side detection target is detected based on detection results of the side detection mode and the moving target (hereinafter referred to as “overlap area moving target”) in the overlap area AW is detected based on detection results of the rear detection mode, the side detection target is register as the tracking target in the side detection area AS and the registered tracking target inherits information of the moving target in the overlap area AW.

Therefore, according to the radar apparatus 101 of the present embodiment, even though the side detection target is a target whose information other than a distance to a target cannot be obtained, it is possible to immediately judge whether or not the side detection target is moving, and further whether or not a side detection target is needed to be tracked, because information of the rear detection mode for the overlap area AW is used. Further, it is possible to improve accuracy of the tracking process in the side detection area AS, because the registered tracking target can inherit and use information detected in the rear detection mode.

In the present embodiment, the operation in the rear detection mode and the target detection process based on detection results in the rear detection mode correspond to a rear detection unit. The operation in the side detection mode and the target detection process based on detection results in the side detection mode correspond to a side detection unit. The configuration in the control circuit 107 obtains speed information showing a speed of the vehicle provided with the radar apparatus 101 corresponds to a speed information acquisition unit. The moving judgment process corresponds to a moving judgment unit.

### Fourth Embodiment

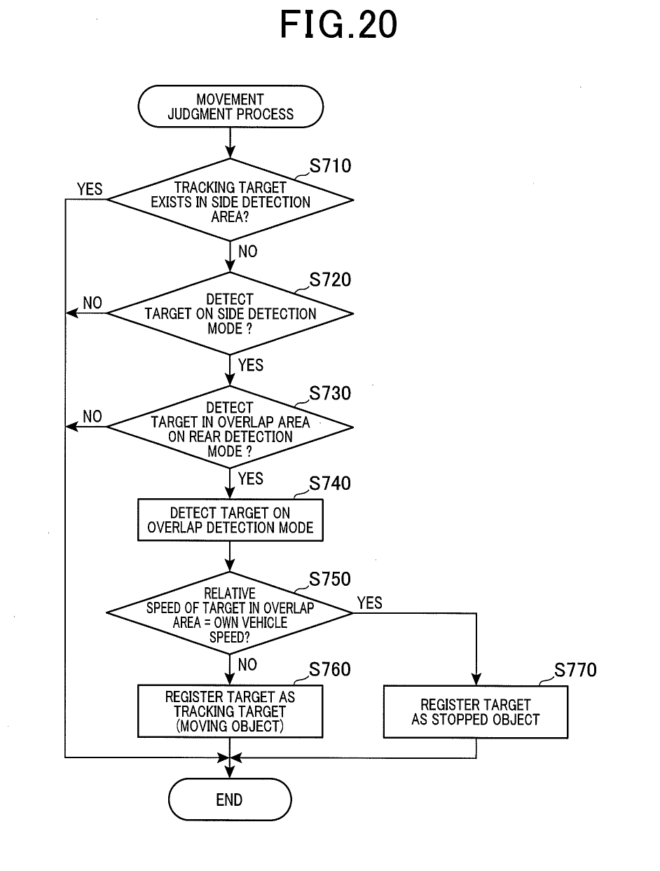

Hereinafter, a fourth embodiment of the present invention is described with reference to FIG. 20. The fourth embodiment is different from the third embodiment in that, in addition to the rear detection mode and the side detection mode, an overlap area detection mode is used as operation mode, and a part of the moving judgment process is different from that of the third embodiment. The configuration of FIG. 16 is also used in the fourth embodiment. Hereinafter, a difference between the fourth embodiment different and the third embodiment is described.

The overlap area detection mode is an operation mode that detects a target in the detection area AW by using the second transmitting antenna 1041 and the first receiving antenna 1032.

In the overlap area detection mode, the signal controller 116 is controlled to supply a triangle-wave-shaped modulating signal M to the VCO 111 in the same manner as the rear detection mode, and to radiate FMCW toward the side detection area AS through the second transmitting antenna 1041 based on the transmission control signal CS.

At the same time, in the receiver 120, in common with the rear detection mode, the reception switch circuit 122 is controlled such that reception signals from the first receiving antenna group 1032 are supplied to the mixer 124 in a time-sharing manner, and therefore, the control circuit 105 inputs signal level of beat signal B from the receiver 120 through an A/D (analog/digital) conversion process. A switch operation of the reception switch circuit 122 is performed at such a rate that can obtain data which has the number of data needed to perform a frequency analysis process in the target detection process during one period of the modulating signal M, while synchronizing with the modulating signal M.

Then, in the target detection process based on detection results obtained in the overlap detection mode, the frequency analysis process for the obtained beat signal B is performed and therefore, a distance and relative speed of a target are calculated by using a well-known technique in the FMCW radar. At the same time, an orientation in which the target exists is detected based on a phase difference between beat signals B that are generated because each antenna element RBj of the first reception antenna group 1032 is different in position in the horizontal direction from one another.

Hereinafter, the movement judgment process is described with reference to a flowchart shown in FIG. 20. Step S710 to S730 are the same as step S610 to S630 of the third embodiment. That is, if (i) the target that is being tracked does not exist (NO in step S710), (ii) the side detection target is detected based on detection results of the side detection mode (YES in step S720), and (iii) the target is detected in the overlap area AW (YES in step S730), the transmitter 110 and the receiver 120 are operated in the overlap detection mode, and then a process to detect a target based on detection results of the overlap detection mode is performed (step S740).

Then, the control circuit 105 judges whether or not a relative speed of the target detected in the overlap area detection mode is the same as own vehicle speed (step S750). As a result, if the relative speed coincides with own vehicle speed (YES in step S750), the control circuit 105 resisters the side detection target as a stopped object in e.g., a memory (not shown) of the control circuit 105 (step S770), and subsequently completes the process.

If the relative speed is not the same as own vehicle speed (NO in step S750), the control circuit 105 registers the side detection target as a tracking target (i.e., moving target) in the side detection area AS in e.g., a memory (not shown) of the control circuit 105, and enables the registered tracking target to inherit information (position, relative speed, etc.) of the target, which is detected based on results of the overlap area mode (step S760), and then completes the process.

Therefore, according to the radar apparatus 101 of the present embodiment, information, which is detected based on detection results of the overlap area mode, is used as information that is inherited by the tracking target in the side detection area AS. Due to this, it is possible to avoid the tracking target from inheriting information of the target that exists in other than the overlap area AW, and to improve reliability of the tracking process in the side detection area AS.

In the present embodiment, the operation in the overlap area detection mode and the target detection process based on detection results in the overlap detection mode correspond to an overlap area detection unit.

### Fifth Embodiment

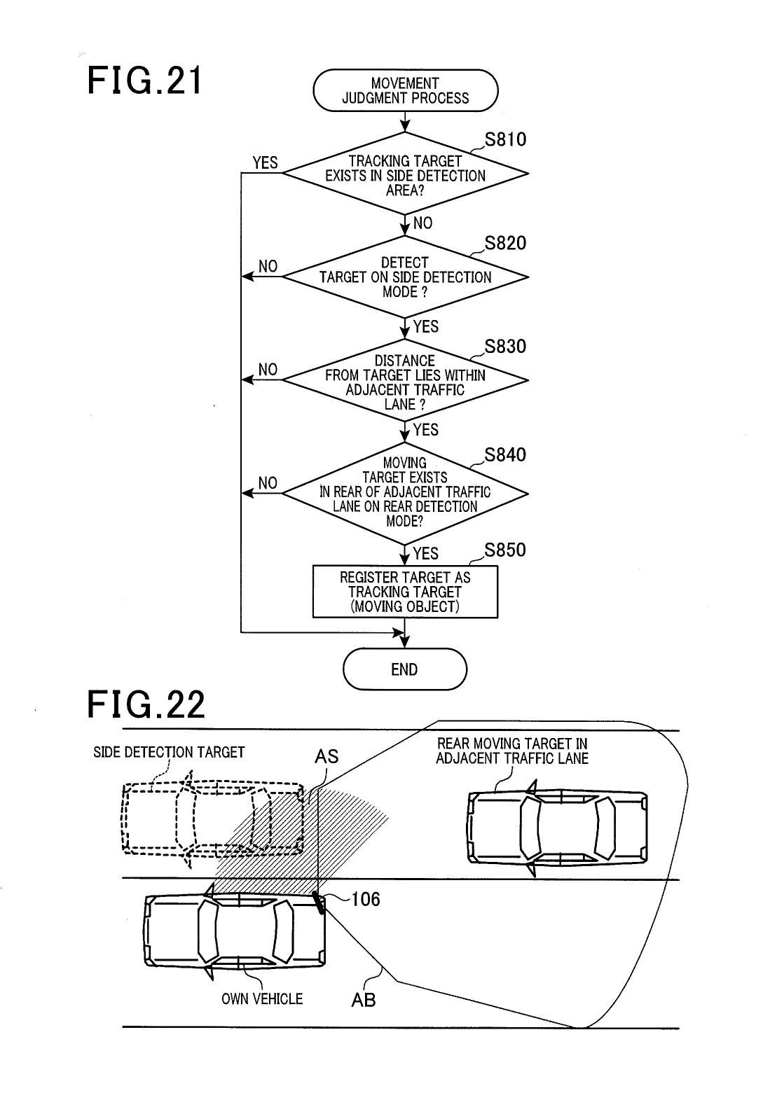

Hereinafter, a fifth embodiment of the present invention is described with reference to FIGS. 21 and 22. The fifth embodiment is different from the third embodiment in a part of the moving judgment process. Hereinafter, a difference between the fifth embodiment different and the third embodiment is described.

Hereinafter, the movement judgment process is described with reference to a flowchart shown in FIG. 21. Step S810 to S820 are the same as step S610 to S620 of the third embodiment. That is, if (i) the target that has tracked does not exist (NO in step S810), and (ii) the side detection target is detected based on detection results of the side detection mode (YES in step S820), the control circuit 105 judges whether or not the side detection target exists in an adjacent traffic lane that is adjacent to a traffic lane on which own vehicle travels (step S830).

As a result, if the side detection target does not exist in the adjacent traffic lane (NO in step S830), the control circuit 105 completes the process. If the side detection target exists in the adjacent traffic lane (YES in step S830), the control circuit 105 determines whether or not a moving target is detected in the rear of the adjacent traffic lane based on results of the rear detection mode (S840).

Then, if the moving target is not detected in the rear of the adjacent traffic lane (NO in step S840), the control circuit 105 completes the process. If the moving target is detected in the rear of the adjacent traffic lane (YES in step S840), the control circuit 105 registers the side detection target as a tracking target in e.g., a memory (not shown) of the control circuit 105 (step S850), and subsequently completes the process.

As described above, in the radar apparatus 101 according to the present embodiment, as shown in FIG. 22, if (i) the target (side detection target) is detected in the side detection area AS, and (ii) the moving target is detected in the rear of the same traffic lane (adjacent traffic lane) as the side detection target, the side detection target is registered as not a stopped object, but a tracking target that may be an object having high probability of being a moving object. This estimation is based on that, if the side detection target is a stopped object, the moving object at the rear of the adjacent traffic lane needs to travel while passing the stopped object.

Therefore, according to the radar apparatus 101 of the present embodiment, it is possible to immediately judge whether or not the side detection target is moving, and further whether or not a side detection target is needed to be tracked, because information of the rear detection mode is used.

### (Modifications)

The third to fifth embodiments have been described so far. However, the present invention is not limited to these embodiments described above but may be implemented in various modes within a scope not departing from the spirit of the present invention.

For example, in the third to fifth embodiments, Yagi antenna is used as the antenna element of the second antenna section 104. However, the antenna element of the second antenna section 104 is not limited to the Yagi antenna, and may an antenna element that can be formed on the same substrate as the first antenna section 103 and whose main radiation direction can be directed toward the end direction, e.g., a tapered slot antenna.

In the third and fourth embodiments, if (i) the target that is being tracked does not exist (NO in steps S610 and S710), (ii) the side detection target is detected based on detection results of the side detection mode (YES in steps S620 and S720), and (iii) the target is detected in the overlap area AW (YES in steps S630 and S730), it is judged whether or not the side detection target is tracked (registered as the tracking target) and the side detection target inherits information based on detection results of the overlap area mode. Alternative to this, when the tracking target in the rear detection area AB enters the overlap area AW, the side detection target which is detected at the same time may be registered as the tracking target in the side detection area AS and may inherit information of the tracking target in the rear detection area AB.

In the third and fifth embodiments, FMCW is used in the rear detection mode and the overlap area detection mode, but alternatively, for example, CW (continuous wave) with no modulation may be used.

In the third and fifth embodiments, the antenna substrate 106 is mounted on the rear-right corner of the vehicle, but alternatively, may be mounted on any one of four corners of the vehicle, or a plurality of portions at the same time.

In the third to fifth embodiments, instead of the antenna apparatus 106 shown in FIGS. 17A and 17B, the antenna apparatus 6 shown in FIGS. 2A, 2B, 3A and 3B, or the antenna apparatus 7 shown in FIGS. 14A and 14B, or the antenna apparatus 8 shown in FIGS. 15A to 15C may be used for the radar apparatus 101. In this case, the effect of the first embodiment can be obtained, in addition to the above effects of the third to fifth embodiments and these modifications.

The present invention may be embodied in several other forms without departing from the spirit thereof. The embodiments and modifications described so far are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

What is claimed is:

1. A radar apparatus, comprising:
an antenna apparatus, including
a substrate that includes two or more pattern-forming layers which are layered via at least one insulating layer, the two or more pattern-forming layers including a first pattern-forming layer and a second pattern-forming layer, the first pattern-forming layer forming one of outer layers located at surfaces of the substrate,
a first antenna that is formed on the first pattern-forming layer, includes a plurality of antenna elements arrayed in a row, and radiates electromagnetic waves in a layer direction of the plurality of layers corresponding to a direction perpendicular to an antenna array direction of the plurality of antenna elements; and
a second antenna that is formed on the second pattern-forming layer, is arranged on at least one side of both sides in the antenna array direction of the plurality of antenna elements of the first antenna section, and radiates electromagnetic waves in the antenna array direction;
a transmitter that selects one of the first antenna and second antenna, and transmits electromagnetic waves via a selected one of the first antenna and second antenna;
a receiver that selects one of the first antenna and second antenna, and receives electromagnetic waves via a selected one of the first antenna and second antenna; and
a signal processor that selects one of the first antenna and second antenna for a transmission and reception, allows electromagnetic waves to be transmitted by the transmitter, and performs a process to detect a target based on a signal received by the receiver.

2. The radar apparatus according to claim 1, wherein
the transmitter includes an amplitude and phase control circuit controls an amplitude and phase of a transmitting signal that is supplied to each of the plurality of antenna elements to change a directivity of electromagnetic waves transmitted through the first antenna.

3. The radar apparatus according to claim 1, wherein
the receiver independently supplies each of reception signals from each of the plurality of antenna elements to the signal processor, and
the signal processor performs a process to estimate a direction of arrival of electromagnetic waves based on phase information of each of the reception signals.

4. The radar apparatus according to claim 1, wherein
each operation of the transmitter and the receiver is controlled such that, when the transmitter transmits electromagnetic waves via the first antenna, the receiver receives electromagnetic waves via the first antenna, and, when the transmitter transmits electromagnetic waves via the second antenna, the receiver receives electromagnetic waves via the second antenna.

5. The radar apparatus according to claim 1, wherein
the transmitter and the receiver have a pulse wave mode that is an operation mode in which pulse waves are transmitted and received and a continuous wave mode that is an operation mode in which continuous waves are transmitted and received.

6. The radar apparatus according to claim 5, wherein
the transmitter and the receiver are operated under the pulse wave mode when the first antenna is used, and are operated under the continuous wave mode when the second antenna is used.

7. An on-board radar system, comprising:
two radar apparatuses that are a first radar apparatus and a second radar apparatus which are mounted on a vehicle, each comprising,
an antenna apparatus, including
a substrate that includes two or more pattern-forming layers which are layered via at least one insulating layer, the two or more pattern-forming layers including a first pattern-forming layer and a second pattern-forming layer, the first pattern-forming layer forming one of outer layers located at surfaces of the substrate,
a first antenna that is formed on the first pattern-forming layer, includes a plurality of antenna elements arrayed in a row, and radiates electromagnetic waves in a layer direction of the plurality of layers corresponding to a direction perpendicular to an antenna array direction of the plurality of antenna elements; and
a second antenna that is formed on the second pattern-forming layer, is arranged on at least one side of both sides in the antenna array direction of the plurality of antenna elements of the first antenna section, and radiates electromagnetic waves in the antenna array direction,
a transmitter that selects one of the first antenna and second antenna, and transmits electromagnetic waves via a selected one of the first antenna and second antenna,
a receiver that selects one of the first antenna and second antenna, and receives electromagnetic waves via a selected one of the first antenna and second antenna, and
a signal processor that selects one of the first antenna and second antenna for a transmission and reception, allows electromagnetic waves to be transmitted by the transmitter, and performs a process to detect a target based on a signal received by the receiver, wherein
provided that a detection area of the first antenna is a first area and a detection area of the second antenna is a second antenna,
the first radar apparatus is mounted on the vehicle such that the first area is positioned at the rear-right side of the vehicle and the second area is positioned at the right side of the vehicle, and
the second radar apparatus is mounted on a vehicle such that the first area is positioned at the rear-left side of the vehicle and the second area is positioned at the left side of the vehicle.

8. The on-board radar system according to claim 7, wherein
the first area is a rear approaching vehicle detection area that is set for detecting another vehicle approaching from the rear of own vehicle, or a rear crossing vehicle detection area that is set for detecting another vehicle crossing the rear of own vehicle on moving into the rear of own vehicle.

9. The on-board radar system according to claim 7, wherein
the second area is a blind spot vehicle detection area that is set for detecting another vehicle which exists in a blind spot of a driver of own vehicle.

10. The on-board radar system according to claim 7, further comprising:
a system controller that operates the two radar apparatus under different operation mode from the each other.

11. A radar apparatus mounted on a vehicle, comprising:
a first antenna and a second antenna mounted on the vehicle;
a rear detection unit that detects a position and relative speed of a target which exists in a rear detection area that is set in the rear of own vehicle, under the condition that electromagnetic waves are transmitted and received through the first antenna;
a side detection unit that detects a distance to a target which exists in a side detection area that is set in the side of own vehicle such that an overlap area is included between the side detection area and the rear detection area, under the condition that electromagnetic waves are transmitted and received through the second antenna;
a vehicle speed acquisition unit that acquires speed information showing a speed of the vehicle; and
a movement judgment unit that judges whether or not a side detection target which is a target detected by the side detection unit is moving based on detection results in the overlap area detected by the rear detection unit and the speed information acquired by the vehicle speed acquisition unit.

12. The radar apparatus according to claim 11, wherein
the movement judgment unit judges that the side detection target is moving, if a target moving in the overlap area is detected by the rear detection unit.

13. The radar apparatus according to claim 11, further comprising:
an overlap area detection unit that detects a target that exists in the overlap area, under the condition that electromagnetic waves are transmitted through the second antenna and are received through the first antenna, wherein
the movement judgment unit controls an operation of the overlap area detection unit such that, if the movement judgment unit judges that the side detection target is moving, the side detection target inherits information of the target detected by the overlap area detection unit.

14. A radar apparatus mounted on a vehicle, comprising:
a first antenna and a second antenna mounted on the vehicle;
a rear detection unit that detects a position and relative speed of a target which exists in a rear detection area that is set in the rear of own vehicle, under the condition that electromagnetic waves are transmitted and received through the first antenna;
a side detection unit that detects a distance to a target which exists in a side detection area that is set in the side of own vehicle, under the condition that electromagnetic waves are transmitted and received through the second antenna;
a movement judgment unit that judges that a side detection target which is a target detected by the side detection unit is moving, if a target is detected in an area of a distance that is regarded as an adjacent traffic lane adjacent to own traffic lane on which own vehicle travels.

15. The radar apparatus according to claim 11, wherein
the first antenna and the second antenna are disposed on the same substrate,
the first antenna radiates electromagnetic waves in a direction perpendicular to a pattern-formed plane of the substrate, and
the second antenna radiates electromagnetic waves in a direction parallel to the pattern-formed plane.
